(19) United States
(12) Patent Application Publication
(10) Pub. No.: US 2007/0078844 A1
(43) Pub. Date: Apr. 5, 2007

(54) RETRIEVAL SYSTEM, INFORMATION PROCESSING SYSTEM AND PROGRAM PRODUCT

(75) Inventors: Kazuma AOKI, Nagoya-shi, Aichi-ken (JP); Satoru YANAGI, Nagoya-shi, Aichi-ken (JP); Kazushige MUROI, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/535,849

(22) Filed: Sep. 27, 2006

(30) Foreign Application Priority Data
Sep. 30, 2005 (JP) 2005-286462

(51) Int. Cl. G06F 17/30

(52) U.S. Cl. 707/4

(57) ABSTRACT

A retrieval system includes a search server and an information processing system. The information processing system includes a generation unit that generates a search formula corresponding to specifics of performed processing and a message to describe a type of a search result corresponding to the search formula, a search request unit that transmits search request data including the search formula and the message to the search server, and a display control unit that displays an image of the response data on a display device. The search server includes a database, a data extraction unit that searches through the database by the search formula and extracts data matching these arch formula, a display data generation unit that generates display data, which include a list of data and the message, and a response unit that transmits the display data to the search request unit.

### CROSS REFERENCE TO RELATED APPLICATION

This application claims priority from Japanese Patent Applications No. 2005-286462, filed Sept. 30, 2005, the contents of which are hereby incorporated by reference into the present application.

### TECHNICAL FIELD

Aspects of the present invention relate to a retrieval system comprising an information processing system and a search server, which searches over a database in accordance with a search formula designated by the information processing system and notifies the information processing system of a retrieval result, as well as to a program employed in this retrieval system.

### BACKGROUND

In a known related-art retrieval system, a personal computer serving as an information processing system and a search server are connected together via a network (e.g., the Internet) In the retrieval system of this type, the personal computer transmits to the search server search request data, including a search formula created by the personal computer. Upon receipt of the search request data, the search server searches over a predetermined database, and returns a retrieval result to the personal computer.

A known search server receives the search request data from the personal computer by an HTTP protocol, and transmits a retrieval result in the form of an HTML document to the personal computer that is the source of the request. In a system using the search server of this type, a personal computer outputs the HTML document to a display device via a known web browser and the like.

Another known retrieval system is to allocate document attributes to respective documents. When a user has issued a command for outputting relevant documents, reference is made to the attribute of the document that serves as a reference. Documents having the same attribute are retrieved from across a database. In accordance with a retrieval result, a list of relevant documents is output to a display device (see JP-A-2000-315203).

In addition to the system for performing a search in response to the user's command, another system known as a retrieval system automatically retrieves data relevant to the processing executed by the information processing system in accordance with the user's command (exclusive of a search command), and displays the retrieval result to the user.

### SUMMARY

Aspects of the present invention provide a technique, which enables display of a retrieval result such that the user can comprehend the type of the retrieval result, and a retrieval system, which exchanges a retrieval result over a network, having a simple configuration.

### BRIEF DESCRIPTION OF THE DRAWINGS

FIG. 1 is a block diagram showing the configuration of a retrieval system according to a present illustrative aspect;

FIG. 2 is a block diagram showing the software configuration of the retrieval system;

FIG. 3 is a descriptive view showing the configuration of event notification data, history data, and search request data;

FIG. 4 is a flowchart showing multifunction machine processing performed by a control section of a multifunction machine;

FIG. 5 is a descriptive view showing the configuration of a detection module table;

FIG. 6A is a flowchart showing document file event detection processing to be performed by a control section of a user terminal, and FIG. 6B is a descriptive view showing example generation of history data through the document file event detection processing;

FIG. 7 is a flowchart showing document file search key generation processing performed by the control section;

FIGS. 8A and 8B are descriptive views showing example generation of an explanation character string in document file search key generation processing;

FIGS. 9A and 9B are descriptive views showing example generation of search request data in document file search key generation processing;

FIG. 10A is a flowchart showing printer event detection processing executed by the control section, and FIG. 10B is a descriptive view showing example generation of history data through printer event detection processing;

FIG. 11 is a flowchart showing printer search key generation processing performed by the control section;

FIGS. 12A and 12B are descriptive views showing example generation of an explanation character string in printer search key generation processing;

FIGS. 13A and 13B are descriptive views showing example generation of search request data in printer search key generation processing;

FIG. 14A is a flowchart showing Fax machine event detection processing executed by the control section, and FIG. 14B is a descriptive view showing example generation of history data through FAX machine event detection processing;

FIG. 15 is a flowchart showing FAX machine search key generation processing performed by the control section;

FIGS. 16A and 16B are descriptive views showing example generation of an explanation character string in FAX machine event detection processing;

FIGS. 17A and 17B are descriptive views showing example generation of search request data in FAX machine event detection processing;

FIG. 18 is a flowchart showing queue management module processing to be performed by the control section;

FIG. 19 is a flowchart showing search control applet processing to be performed by the control section;

FIG. 20 is a flowchart showing display control module processing to be performed by the control section;

FIG. 21 is a descriptive view showing the configuration of a search result display screen;

FIG. 22 is a flowchart showing history management server processing performed by a control section of a search server;

FIG. 23 is a descriptive view showing the configuration of the history database;

FIG. 24 is a flowchart showing search front-end processor processing performed by the control section;

FIGS. 25A to 25C are descriptive views showing the configuration of a display script generated by search front-end processor processing; and

FIG. 26 is a flowchart showing search engine processing performed by the control section.

### DETAILED DESCRIPTION

General Overview

According to an aspect of the present invention, a retrieval system comprises a search server and an information processing system. The information processing system comprises a first communication unit capable of establishing communication with the search server; a processing execution unit, which executes a processing operation; a generation unit; a search request unit; and a display control unit.

In this information processing system, when the processing execution unit performs a predetermined type of processing, the generation unit generates a search formula corresponding to specifics of processing performed and a message that describes a type of a search result corresponding to the search formula, based on the specifics of processing. Further, the search request unit transmits search request data including the search formula and the message generated by the generation unit to the search server via the first communication unit. In addition, upon receipt of response data in answer to the search request data from the search server via the first communication unit, the display control unit displays an image of the response data on a display device.

The search server of the retrieval system comprises: a second communication unit capable of establishing communication with the first communication unit of the information processing system; a database that stores data; a data extraction unit; a display data generation unit; and a response unit.

In the search server, upon receipt of the search request data from the information processing system via the second communication unit, the data extraction unit searches through the database by the search formula written in the search request data and extracts from the database data matching the search formula. The display data generation unit generates, as specifics of a result of search performed by the search formula written in the search request data, data (e.g., an HTML document), which include a list of data extracted by the data extraction unit and the message written in the search request data and by which an image showing the list and the message is displayed on the display device. Additionally, the response unit transmits, as a response to the search request data, the display data generated by the display data generation unit, via the second communication unit, to a device, which has originated transmission of the search request data.

As mentioned above, in the retrieval system of the aspect of the present invention, when a search formula is generated from specifics of processing having been executed by the processing execution unit, a message, which describes the type of a search result corresponding to the search formula is generated from specifics of the performed processing. The message is displayed in conjunction with the search result. Accordingly, the user can readily ascertain the type of processing by which the search formula has been generated, the search formula corresponding to the search list indicating the data list (in other words: the type of processing related to the data list). Therefore, this retrieval system can display a search result in such a way that the user can comprehend the type of the search result much better than in the related art.

According to illustrative aspect of the present invention, the information processing system transmits the message generated during generation of the search formula to the search server along with the search formula, and transmits from the search server the display data including the search result and the message to the information processing system. Accordingly, the information processing system can save management of messages.

When the information processing system does not transmit the message generated during generation of the search formula to the search server along with the search formula and manages the messages by itself, the message corresponding to the search result must be identified by a management table or the like during receipt of the search result. Consequently, according to the technique for managing the message in the information processing system, management of messages performed by the information processing system will become complicated.

In contrast, according to illustrative aspect of the present invention, the information processing system does not need to associate the search result (a data list) with the message. Accordingly, message display processing of the information processing system becomes simple. Further, according to illustrative aspect of the present invention, processing for associating the search result with the message can be made simple even in the entire search system, thereby offering great convenience.

The above-described processing execution unit executes processing based on the user's operation. In the search system where the processing execution unit is configured in this way, the search result can be displayed to the user by addition of the message so that the correspondence between specifics of operation and the search result can be comprehended.

In the above configuration, data relevant to the data handled by the processing execution unit are preferably applied to the system.

In the retrieval system according to a second aspect of the present invention, the search server has a database having various sets of data relevant to data handled by the processing execution unit. The generation unit is configured so as to generate a search formula corresponding to the data having been handled by a processing execution unit during performance of processing.

When there is generated a search formula corresponding to the data handled during execution of processing performed by the processing execution unit, the user may fail to comprehend the meaning of a data list when only the data list obtained as a result of a search is displayed to the user. Specifically, when only a data list is simply displayed, the user cannot sufficiently comprehend the type of processing that has been performed on data, the data being related to the data list, and hence the data list may be useless for the user.

In contrast, according to illustrative aspect of the present invention, the message—which describes the type of the search result generated on the basis of the specifics of processing having been executed—is displayed along with the search result. Accordingly, the user can sufficiently understand the type of processing having been performed on data are relevant to the data indicated by the search result.

Further, illustrative aspect of the invention is also effective for a system which accumulates in a database managed by the search server history data showing specifics of processing performed in the information processing system.

A search system according to a third aspect of the invention is configured such that the information processing system generates, by use of a history transmission unit, history data showing specifics of processing to be executed every time the processing execution performs processing of predetermined type, and transmits the generated history data to the search server via the first communication unit; and

upon receipt of history data from the information processing system via the second communication unit, the search server registers the history data into the database by the registration unit.

In this retrieval system, the data list pertaining to the history of execution of processing is displayed in the information processing system as a search result on the display device in synchronism with operation of the processing execution unit. According to illustrative aspect of the present invention, the type of the search result can be explained to the user by the display of the message. Therefore, the user can readily comprehend the type of processing pertaining to the data list of an execution history, the data list corresponding to the search result.

In the retrieval system according to a fourth aspect of the invention, the history transmission unit generates as the history data an address of a location where the data handled during execution of processing are stored and a date when processing has been executed; and the generation unit generates a search formula corresponding to an address where the data having been handled by a processing execution unit during performance of processing are to be stored, as a formula corresponding to specifics to be executed.

According to this retrieval system, the information processing system can acquire, from the search server, a list of data, which have been handled by the processing execution unit in the past as determined by the search time and data (data having the same directory or the like), which have an attribute identical or analogous with that of the data handled in the processing having triggered the search. This list can be displayed for the user, and a search result can be displayed to the user in a self-explanatory manner by the message.

The retrieval system according to a fifth aspect of the invention is configured such that the history transmission unit generates, as the history data, data showing an address of a location where the data handled during execution of processing are stored, a date and time when processing is executed, and the type of performed processing; and such that the generation unit generates, as a formula corresponding to specifics to be executed, a search formula, which corresponds to an address where the data having been handled during performance of processing are to be stored and which takes as an object of search data corresponding to the type of performed processing.

According to this retrieval system, the information processing system can acquire, from the search server, a list of data (data having the same directory or the like), which have an attribute identical or analogous with that of the data handled in the processing having triggered the search and data, which are handled in processing of the same type. This list can be displayed for the user, and a search result can be displayed to the user in a self-explanatory manner by the message.

Particularly, according to this retrieval system, a complicated search as mentioned previously is performed. Therefore, the search result may fail to be useful for the user by a mere display of a search result (data list). However, in illustrative aspect of the present invention, a message describing the type of the search result is displayed along with the search result. Hence, the search result can be provided to the user in a useful manner. Specifically, according to the search system of this type, the display of the message describing the type of a search result is very effective.

Although the information processing system may be configured as a single device, it may also be configured as a system formed from a plurality of devices. The retrieval system according to a sixth aspect of the invention is configured such that the information processing system comprises a processing execution device having the processing execution unit; and a communications device having the first communication unit, the generation unit, the search request unit, and the display control unit. In this retrieval system, the generation unit is configured so as to be able to detect operation of the processing execution unit belonging to the processing execution device, and generates, when the processing execution unit of the processing execution device has performed the predetermined type of processing, a search formula corresponding to specifics of processing to be executed and a message describing the type of a search result corresponding to the search formula based on the specifics of processing to be executed.

According to this retrieval system, the processing execution device and the communications device are configured separately, thereby increasing the degree of freedom in designing the system. Specifically, so long as the communications device is configured so as to be compatible with a plurality of types of processing execution devices, the user can acquire the search result attributable to specifics of various processing operations along with a message describing the type of the search result, by a combination of the communications device and the processing execution device.

According to a seventh aspect of the present invention, a computer program product for enabling a computer to retrieve, comprising: software instructions for enabling the computer to perform predetermined operations, and a computer readable medium bearing the software instructions. The predetermined operations including the steps of: searching, upon receipt of search request data including a search formula and a message, through a predetermined database by the search formula included in the search request data and extracting from the database data matching the search formula; generating, as specifics of a result of search performed by the search formula included in the search request data, display data, which include a list of extracted data and the message included in the search request data and by which an image showing the list and the message is displayed on a display device; transmitting the display data as a response to the search request data to a device transmitting the search request data; generating, when a predetermined type of processing is performed in a system to be monitored, a search formula corresponding to specifics of the performed processing and a message describing a type of a search result corresponding to the search formula based on the specifics of the performed processing; and transmitting, to the server, search request data including the generated search formula and the generated message.

According to this program, a message describing the type of a search result is transmitted to the search server in conjunction with the search formula. Accordingly, the computer does not need to manage the messages generated during generation of the search formula. Further, during receipt of a search result, the search server does not need to identify a message corresponding to the search result. Therefore, by this program, procedures for displaying the message describing the type of the search result can be readily performed in conjunction with the search result.

Further, by a program, the computer can be caused to implement the function of the above display control unit. For instance, a web browser, which enables display of an HTML document can be mentioned as a program for causing the computer to act as the display control unit.

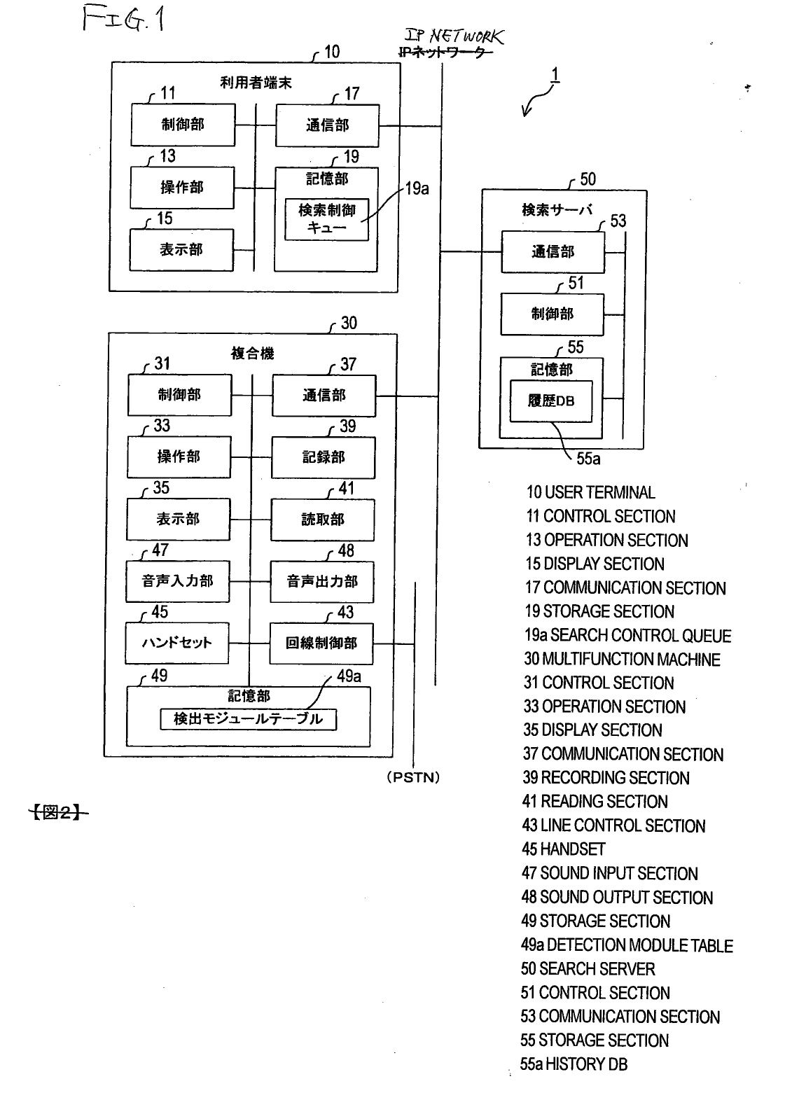

Illustrative aspects of the present invention will be described hereinbelow with reference to the drawings. FIG. 1 is a block diagram showing the configuration of a retrieval system.

[General Configuration of a Retrieval System]

As shown in FIG. 1, a retrieval system 1 of the present illustrative aspect is configured such that a user terminal 10, a digital multifunction machine 30, and a search server 50 are connected so as to be able to communicate with each other via a TCP/IP network.

The user terminal 10 comprises a control section 11 formed from a CPU or the like; an operation section 13 formed from a keyboard, a pointing device, or the like, which can be used by the user; a display section 15 equipped with a liquid-crystal monitor; a communications section 17, which is connected to the network and is able to communicate with the multifunction machine 30 and the search server 50; and a storage section 19 formed from a hard disk drive or the like. The storage section 19 has an operating system (OS), a program for implementing various processing operations to be described later, a search control queue 19a, which is a queue for search control purpose, and the like.

The multifunction machine 30 comprises a control section 31 formed from a CPU or the like; an operation section 33 having various keys, which can be operated by the user; a display section 35 having a liquid-crystal monitor; a communications section 37, which is connected to the network and is able to communicate with the user terminal 10; a recording section 39 capable of forming an image on a sheet; a reading section 41 capable of reading a document; a line control section 43 connected to a PSTN (Public Switched Telephone Network); a handset 45 having a built-in microphone and a built-in earphone for voice conversation; a sound input section 47 formed from a microphone for hands-free telephone conversation purpose, or the like; a sound output section 48 formed from a speaker for regenerating the voice of the party on the other end during hands-free telephone conversation; and a storage section 49, which is formed from a hard disk drive, NVRAM, or the like, and stores various types of data.

Upon receipt of a command from the control section 31, the recording section 39 operates and picks up a sheet from an unillustrated sheet-feeding section, and forms an image from data input by the control section 31, by an inkjet or laser printer. Upon receipt of the command from the control section 31, the reading section 41 optically reads a document set on a platen glass or in an ADF (Automatic Document Feeder), and inputs a result of reading to the control section 31.

Upon receipt of a command from the control section 31, the line control section 43 originates a call to an external terminal device assigned a telephone number designated by the control section 31. Upon receipt of a call from the external terminal device, the line control section 43 connects together the multifunction machine 30 and the external terminal device so as to be able to establish communication.

The control section 31 controls individual sections of the device, thereby implementing a printer function, a scanner function, a copier function, a facsimile function, a PCFAX transmission function, a telephone function, and the like.

Specifically, upon receipt of a print command from the user terminal 10, the control section 31 performs printer processing, to thereby print on a sheet an image formed from the data to be printed received along with the print command, via the recording section 39 (a printer function). Upon receipt of an input of a reading command from the operation section 33 or the user terminal 10, the control section 31 performs scanner processing, generates via the reading section 41 read image data showing a read image of a document set on the reading section 41, and stores the image data in the storage section 49 (the scanner function).

In addition, upon receipt of an input of a copy command from the operation section 33 or the user terminal 10, the control section 31 performs copy processing; reads via the reading section 41 a document set on the reading section 41; and on the basis of the reading result reproduces the document set on the reading section 41 on a sheet via the recording section 39 (the copy function).

Upon receipt of an input of a FAX transmission command from the operation section 33 or the user terminal 10, the control section 31 performs FAX transmission processing; and transmits, via the line control section 43, read image data pertaining to the document read by the reading section 41 as FAX data to an external terminal device (a facsimile device) assigned the telephone number input along with the FAX transmission command. In addition, when the line control section 43 has received an initial signal (a CNG signal) of FAX communication from the external terminal device (a facsimile device), a FAX receipt command from the external terminal device is determined to have been input, whereupon FAX receipt processing is carried out. The image data transmitted from the external terminal device are received via the line control section 43, and the image data are printed on a sheet via the control section 39. Further, the image data are stored in the storage section 49 via the recording section 39 along with a phone number of the external terminal device (a FAX function).

Upon receipt of a PCFAX transmission command from the user terminal 10, the control section 31 performs PCFAX transmission processing, thereby transmitting via the line control section 43 the image data received from the user terminal 10 along with the PCFAX transmission command, as FAX data to the external terminal device (a facsimile device) assigned the phone number specified via the user terminal 10 (a PCFAX transmission function).

In addition, in response to a call from the external terminal device, the line control section 43 outputs a ringing tone. In response to the ringing tone, the user picks up the handset 45 or presses a hands-free key (not shown); the conversation start command is deemed as have been input; and the control section 31 performs phone processing to thereby transmit a sound signal of the user input via the handset 45 or the sound input section 47 to the external terminal device via the line control section 43 and to input the sound signal received by the line control section 43 from the external terminal device to the handset 45 or the sound output section 48. In response to the sound signal exchanged between the line control section 43 and the handset 45 or among the line control section 43, the sound input section 47, and the sound output section 48, the control section 31 records telephone conversation; records into the storage section 49 sound data showing details of the telephone conversation; and records in the storage section 49 the phone number of the external terminal device in association with the sound data (the phone function).

When call-originating operation has been performed via the operation section 33 and connection with the external terminal device has been established, the control section 31 performs phone processing on the assumption that a phone conversation start command has been received; records sound data expressing details of the phone conversation into the storage section 49; and records the phone number of the external terminal device into the memory in association with the sound data (the phone function).

The search server 50 comprises a control section 51 formed from a CPU or the like; a communications section 53, which is connected to a network and is able to communicate with the multifunction machine 30 and the user terminal 10 (the communications section 17); and a storage section 55 formed from a hard disk drive or the like. The storage section 55 has various types of programs such as a program for implementing the function of a web server, and a history database 55a formed from a group of records of history data representing the history of execution of each of the processing operations performed by the user terminal 10 and the multifunction machine 30.

[Software Configuration of the Search System]

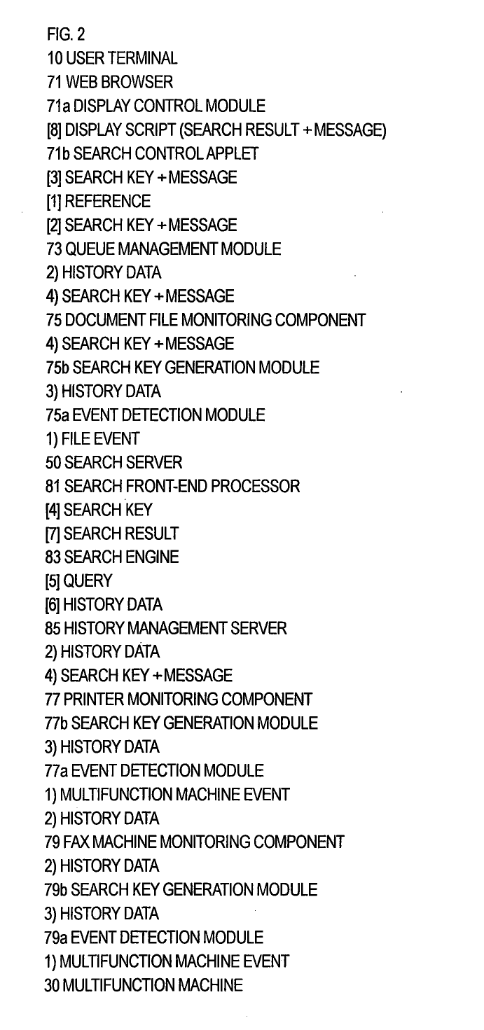

The software configuration of the search system 1 will now be described. FIG. 2 is a descriptive view showing the software configuration of the search system 1.

The user terminal 10 of the illustrative aspect has, as programs to be executed by the control section 11, a web browser 71, a queue management module 73, a document file monitoring component 75, a printer monitoring component 77, and a FAX machine monitoring component 79.

The document file monitoring component 75 comprises an event detection module 75a and a search key generation module 75b, by which the control section 11 executes procedures of detecting a file event in a file system operated by the OS and generating history data corresponding to the detected file event. The search key generation module 75b is configured as a program for causing the control section 11 to generate a search key corresponding to the detected event from the history data generated by the event detection module 75a and execute procedures for generating a message showing the type of a search result.

The printer monitoring component 77 has an event detection module 77a and a search key generation module 77b, by which the control section 11 executes procedures for detecting an event related to the printer function of the multifunction machine 30 and generating history data corresponding to the detected event. The search key generation module 77b is formed as a program for causing the control section 11 to execute procedures for generating a search key and a message showing the type of a search result from the history data generated by the event detection module 77a.

The FAX machine monitoring component 79 has an event detection module 79a and a search key generation module 79b, which are used for causing the control section 11 to detect an event associated with the FAX function or the PCFAX transmission function of the multifunction machine 30 and generate history data associated with the detected event. The search key generation module 79b is formed as a program used for causing the control section 11 to perform procedures for generating a search key and a message showing the type of a search result from the history data generated by the event detection module 79a.

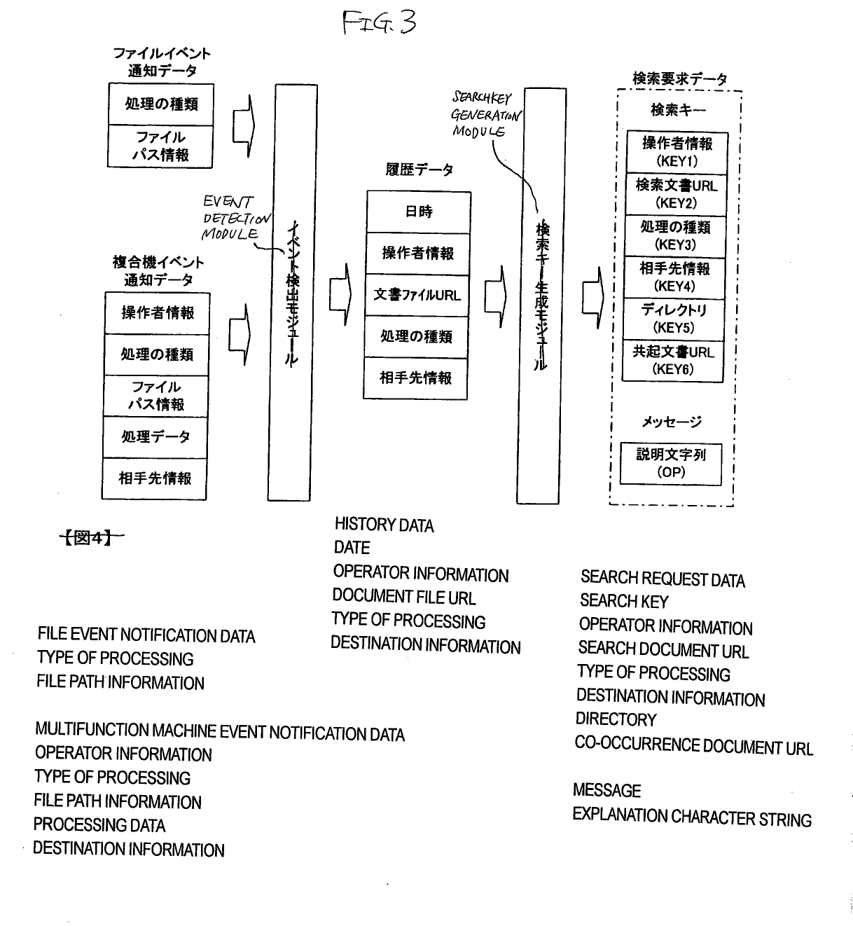

The respective monitoring components 75, 77, 79 to generate, as the history data, history data having the configuration shown in FIG. 3. The search key generation modules 75b, 77b, and 79b generate search request data including a search key and a message.

Meanwhile, the queue management module 73 is formed as a program used for causing the control section 11 to perform: procedures for registering, in a queue (the search control queue 19a), the search keys generated by the respective monitoring components 75 to 79 and search request data having messages; and procedures for, upon receipt from the web browser 71 of a request for referring to the queue, reading in an FIFO format search request data registered in the queue and returning the thus-read search request data to the source of the reference request.

The web browser 71 has a display control module 71a and a search control applet 71b, which are used for causing the control section 11 to perform procedures for comprehending a display script (an HTML document) including a message, which shows a search result supplied from the search server 50 and the type of the search result; and for displaying on the display section 15 an image showing the search result and a message. The search control applet 71b is formed as a program used for causing the control section 11 to perform procedures for acquiring the search request data registered in the search control queue 19a from the search control queue 19a via the queue control module 73, and transmitting the search request data to the search server 50 via the communications section 17.

The search server 50 has, as programs to be executed by the control section 51, a search front-end processor 81, a search engine 83, and a history management server program 85.

The search front-end processor 81 is formed as a program used for causing the control section 51 to perform procedures for receiving the search request data transmitted from the user terminal 10 and inputting the search request data to the search engine 83, and procedures for generating, from a search result obtained by the search engine 83, a display script (an HTML document) including a message, which shows the search result and the type of the search result; and for returning the display script to the user terminal 10.

The search engine 83 is formed as a program for causing the control section 51 to perform procedures for generating a query from the search request data input by the search front-end processor 81, inputting the query to the history management server program 85, and inputting as a search result return data obtained from the history management server 85 to the search front-end processor 81.

The history management server program 85 is formed as a program for causing the control section 51 to perform procedures of registering the history data sent from the user terminal 10 into the history database 55a and of, upon receipt of the query from the search engine 83, returning to the search engine 83 a record in the history database 55a corresponding to the query.

The software configuration of the search system 1 has been described thus far. There will now be specifically described processing to be performed by the multifunction machine 30, the user terminal 10, and the search server 50.

[Multifunction Machine Processing]

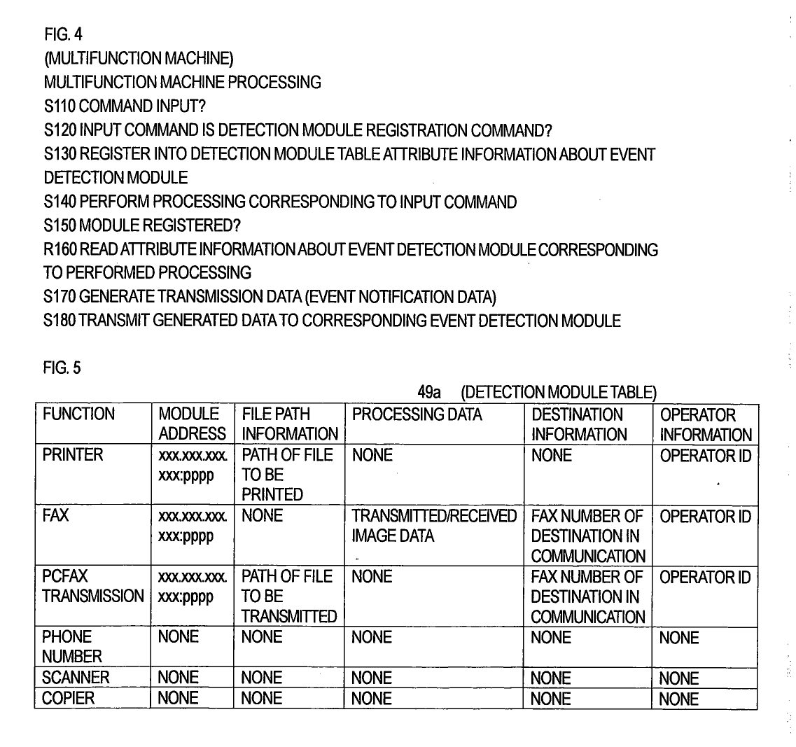

FIG. 4 is a flowchart showing multifunction machine processing performed by the control section 31 of the multifunction machine 30. When multifunction machine processing is initiated, the control section 31 stays in a standby condition until input of any one of the print command, the reading command, the copy command, the FAX transmission command, the FAX receipt command, the PCFAX transmission command, the phone conversation start command, and the detection module registration command (when No is selected in S110). Upon receipt of an input of the command (when Yes is selected in S110), a determination is made as to whether or not the input command is the detection module registration command (S120) When the input command is determined to be the detection module registration command (when Yes is selected in S120), attribute information about the event detection module is registered in the detection module table 49a (S130).

FIG. 5 is a descriptive view showing the configuration of a detection module table 49a belonging to the storage section 49. As shown in FIG. 5, the detection module table 49a has a “module address” field, a “file path information” field, a “processing data” field, a “destination information” field, and an “operator information” field, as fields used for describing attribute information about the event detection module, for each of the functions; namely, the printer function, the FAX function, the PCFAX transmission function, the phone function, the scanner function, and the copy function.

In S130, the control section 31 writes the attribute information input via the operation section 33 into the field corresponding to the function designated by the user, by the detection module registration command input via the operation section 33. Specifically, the control section 31 writes, into the “module address” field corresponding to the designated function, an IP address and a port number of the event detection module input via the operation section 33; and writes, into the “file path information” field, a code representing the type of file path information to be transmitted to the event detection module. Moreover, the control section 31 writes, into the “processing data” code, a code representing the type of processing data to be transmitted to the event detection module; and writes, into the “destination information” field, a code representing the type of destination information to be transmitted to the event detection module. In addition, the control section 31 writes into the “operator information” field a code representing the type of operator information to be transmitted to the event detection module.

Thus, when the attribute information about the event detection module is registered in the detection module table 49a, the control section 31 proceeds to S110 and remains in a standby condition until the next command is input.

When the input command is determined not to be the detection module registration command (when No is selected in S120), the control section 31 proceeds to S140 and performs processing corresponding to the input command. For instance, upon receipt of an input of the print command, the control section 31 performs printer processing. Upon receipt of an input of the reading command, the control section 31 performs the scanner processing.

Upon completion of processing pertaining to S140, the control section 31 determines whether or not the attribute information about the event detection module corresponding to the processing performed in S140 is registered in the detection module table 49a (S150). Specifically, when printer processing has been performed, a determination is made as to whether or not the attribute information about the event detection module corresponding to the printer function is registered in the detection module table 49a. When either FAX transmission processing or FAX receipt processing has been performed, a determination is made as to whether or not attribute information about the event detection module corresponding to the FAX function is registered in the detection module table 49a. Further, when PCFAX transmission processing has been performed, a determination is made as to whether or not attribute information about the event detection module corresponding to the PCFAX transmission function is registered in the detection module table 49a.

When phone processing is performed, a determination is made as to whether or not attribute information about the event detection module corresponding to the phone function is registered in the detection module table 49a. When scanner processing has been performed, a determination is made as to whether or not attribute information about the event detection module corresponding to the scanner function is registered in the detection module table 49a. When copy processing has been performed, a determination is made as to whether or not attribute information about the event detection module corresponding to the copy function is registered in the detection module table 49a.

When the corresponding attribute information is determined not to be registered (when No is selected in S150), the control section 31 proceeds to S110. When the corresponding attribute information is determined to be registered (when Yes is selected in S150), the control section 31 proceeds to S160. When having proceeded to S160, the control section 31 reads the registered attribute information, and in S170 generates event notification data addressed to the IP address and the port number of the event detection module indicated by the attribute information. As shown in FIG. 3, the event notification data are formed so as to comprise operator information, information showing the type of executed processing, file path information, processing data, and destination information.

When having generated the event notification data in S170, the control section 31 transmits the event notification data to the network via the communications section 37 (S180). The event notification data are input to the event detection modules 77a, 79a corresponding to the IP address and the port number, which are taken as the destination. In the present illustrative aspect, as a result of the attribute information shown in FIG. 3 being registered in the detection module table 49a, the control section 31 performs processing provided below in S150 to S170.

When having performed printer processing in S140, the control section 31 makes an affirmative determination in S150, and reads attribute information about the event detection module corresponding to the printer function (S160). The control section 31 then generates event notification data including: as operator information, descriptions about an ID of an operator who has input the print command; as file path information, descriptions about a full path (an absolute path) of the data file, which is a data file used for printer processing (i.e., the data file including data to be printed) and is retained in the user terminal 10; and, as information showing the type of processing, descriptions about a code representing the “printer” (S170).

When having performed FAX transmission processing in S140, the control section 31 selects Yes in S150 and reads attribute information about the event detection module corresponding to the FAX function (S160). The control section 31 then generates event notification data including: as operator information, descriptions about an ID of an operator who has input the FAX transmission command; as information showing the type of processing, descriptions about a code representing the “FAX transmission”; as processing data, storage of image data transmitted to the external terminal device during FAX transmission; and, as destination information, descriptions about a phone number of a destination of communication employed during FAX transmission operation (S170).

When having performed FAX receipt processing in S140, the control section 31 selects Yes in S150 and reads attribute information about the event detection module corresponding to the FAX function (S160). The control section 31 then generates event notification data including: as operator information, descriptions about an ID of an operator who has input the FAX receipt command; as information showing the type of processing, descriptions about a code representing the “FAX receipt”; as processing data, storage of image data transmitted to the external terminal device during FAX transmission; and, as destination information, descriptions about a phone number of a destination of communication employed during FAX receipt operation (S170).

When having performed PCFAX transmission processing S140, the control section 31 makes an affirmative determination in S150, and reads attribute information about the event detection module corresponding to the FAX function (S160). The control section 31 then generates event notification data including: as operator information, descriptions about an ID of an operator who has input the PCFAX transmission command; as information showing the type of processing, descriptions about a code representing the “PCFAX transmission”; as file path information, descriptions about a full path of the data file, which is a data file used for PCFAX transmission processing (i.e., the data file including data to be transmitted) and is retained in the user terminal 10; and, as destination information, descriptions about a phone number of a destination of communication employed during PCFAX transmission operation (S170).

The event notification data are generated as mentioned above (S170), and the thus-generated event notification data are transmitted to the corresponding event detection modules 77a, 79a (S180), whereupon the control section 31 proceeds to S110. Every time a command is input, processing subsequent to S120 is performed.

Processing to be performed by the multifunction machine 30 has been described thus far. Next will be described processing to be performed by the user terminal 10.

[Document File Event Detection Processing]

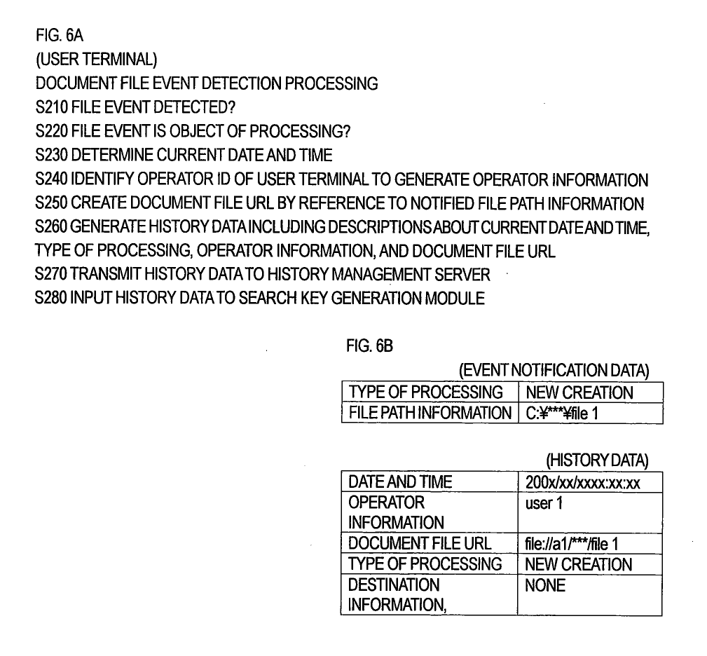

FIG. 6A is a flowchart showing document file event detection processing to be performed by the control section 11 of the user terminal 10. FIG. 6B is a descriptive view showing an example of generation of history data through the document file event detection processing. The document file event detection processing is implemented by the event detection module 75a.

When document file event detection processing is initiated, the control section 11 remains in a standby condition until a file event arises in the file system operated by the OS installed therein (when No is selected in S210). When a file event has arisen (when Yes is selected in S210), processing proceeds to S220.

When processing has proceeded to S220, the control section 11 determines, from the event notification data representing specifics of the file event notified by the OS, which one of an event for newly creating a data file in response to the user's operation, an event for opening a data file, and an event for closing a data file corresponds to the occurred file event. The event notification data generated by the OS are assumed to include the type of processing performed by the OS (in other words, the type of an event) and file path information showing a full path to the data file provided for processing (see FIGS. 3 and 6B).

When the control section 11 has determined which one of an event for newly creating a data file in response to the user's operation, an event for opening a data file, and an event for closing a data file corresponds to the occurred file event (when Yes is selected in S220), processing proceeds to S230. When the control section 11 has determined that the event having occurred does not correspond to any one these events (when No is selected in S220), processing proceeds to S210, and the control section 11 remains in a standby condition until the next event arises.

When processing has proceeded to S230, the control section 11 identifies a current date, and processing then proceeds to S240. In this step, the ID of the operator of the user terminal 10 is acquired from the OS, and operator information having a description of the operator's ID is generated. Further, after completion of processing, the control section 11 generates, from the file path information in the event notification data, a document file URL including a description in URL format of the location of the data file indicated by the file path information (S250).

When having completed processing pertaining to S250, the control section 11 generates history data including information showing the identified date, the operator information generated in S240, the document file URL generated in S250, and information showing the type of processing indicated by the event notification data (any one of a code representing a “creation of a new file,” a code showing “file open,” and a code showing “file close”) (S260).

Upon completion of processing pertaining to S260, the control section 11 inputs the thus-generated history data into the history management server program 85, and transmits the program to the search server 50 via the communications section 17 (S270). At the time of transmission, the registration command is appended to the history data, and the history data are transmitted to the search server 50. Upon completion of processing, the control section 11 inputs the thus-generated history data to the search key generation module 75b (S280). Subsequently, processing proceeds to S210.

[Document File Search Key Generation Processing]

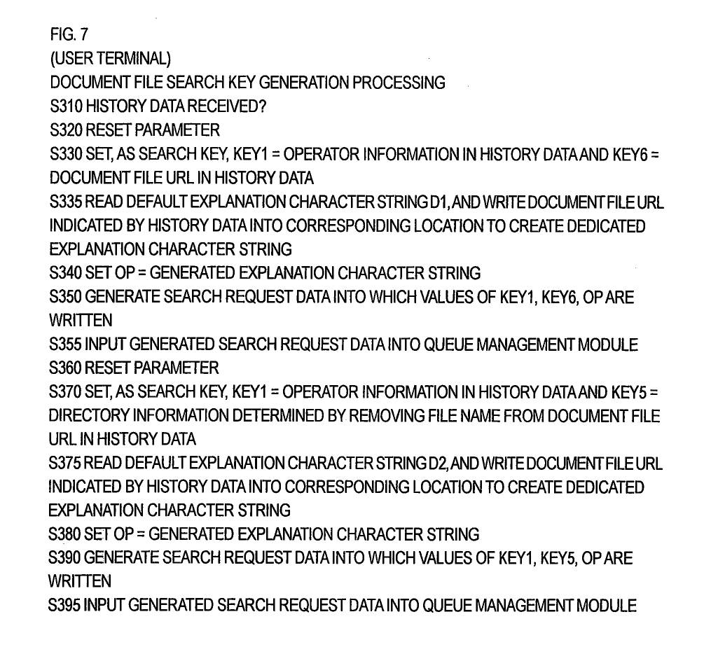

Subsequently, the document file search key generation processing performed by the control section 11 of the user terminal 10 will be described. FIG. 7 is a flowchart showing the document file search key generation processing performed by the control section 11 of the user terminal 10. This document file search key generation processing is implemented by the search key generation module 75b.

When document file search key generation processing is initiated, the control section 11 remains in a standby condition until history data are input by the event detection module 75a (when No is selected in S310). When the history data are input (when Yes is selected in S310), processing proceeds to S330 after resetting of parameters (KEY 1 to KEY 6, OP) to be used for setting a search key (S320).

The variable KEY 1 is a parameter used for extracting from the history database 55a the history data having information about specific operator. The variable KEY 2 is a parameter used for extracting from the history database 55a the history data having a specific document file URL. The variable KEY 3 is a parameter used for extracting from the history database 55a history data representing the type of specific processing. The variable KEY 4 is a parameter used for extracting from the history database 55a history data having information about a specific destination. The variable KEY 5 is a parameter used for extracting from the history database 55a the history data having a document file URL showing a specific directory. The variable KEY 6 is a parameter used for extracting from the history database 55a the history data pertaining to a data file opened at the same time when the specific data file has been opened.

When processing has proceeded to S330, the control section 11 sets on the variable KEY 1 as a search key a value (an operator ID) showing the operator information about the input history data. The control section 11 sets in the variable KEY 6 a document file URL showing the input history data. A default explanation character string D1 stored in the storage section 19 is read from the storage section 19, and a document file URL showing history data is written in an insertion field of the descriptive character string D1, thereby generating a dedicated descriptive character string (S335).

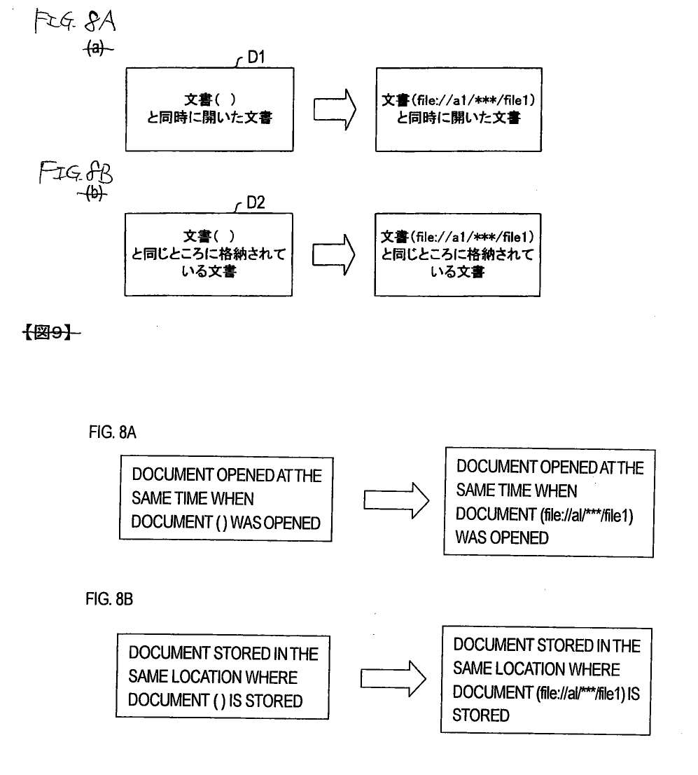

FIG. 8A is a descriptive view showing example processing pertaining to S335. As shown in FIG. 8A, in S335 the document file URL showing history data is written into the insertion field of the explanation character string D1, thereby creating a message (a dedicated explanation character string) for describing the type of a search result acquired by the search formula formed from the variable KEY 1 and the variable KEY 6. By settings pertaining to S330, a list of a data file opened at the same time when the data file corresponding to the document file URL indicated by the history data has been opened is obtained as a search result. Therefore, a message to this effect is created in S335.

After having completed processing pertaining to S335, the control section 11 proceeds to processing pertaining to S340, where the descriptive character string created in S335 is set in a variable OP. The variable OP is a parameter used for setting a message, which describes the type of the search result.

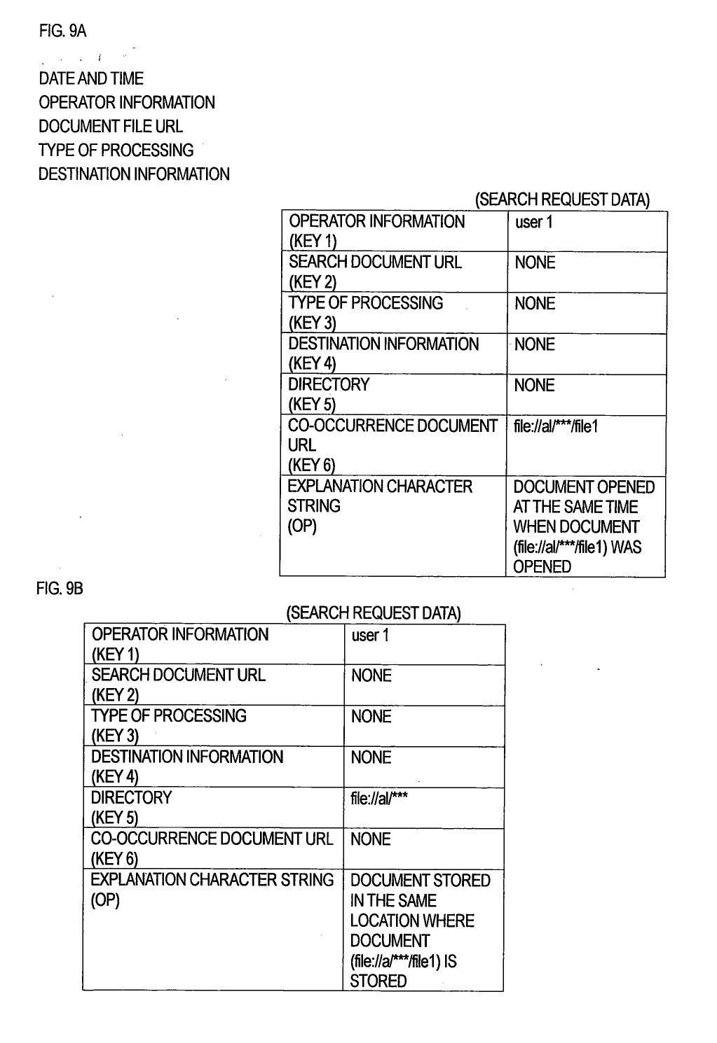

After having completed processing pertaining to S340, the control section 11 generates search request data showing respective values of the set variables KEY 1, KEY 6, and OP (S350). FIG. 9A is a descriptive view showing example generation of search request data pertaining to S350. As shown in FIGS. 3 and 9A, the search request data include values of the variables KEY 1 to KEY 6 and the value of the variable OP. In S350, NULL values are described or no values are assumed to be described as values of the variables KEY 2 to KEY 5 having not been set through processing pertaining to S330, S340, thereby showing that the search keys corresponding to the variables KEY 2 to KEY 5 are not set in the search request data.

After having completed processing pertaining to S350, the control section 11 inputs the search request data generated in S350 into the queue management module 73 along with a registration command (S355). Subsequently, processing proceeds to S360.

When processing has proceeded to S360, the control section 11 proceeds to S370 after having again reset the parameters (KEY 1 to KEY 6, and OP) used for setting a search key. After having proceeded to S370, the control section 11 sets, as a search key, a value (an operator ID) indicating operator information about the input history data is set in the variable KEY 1. Further, the control section 11 sets, in the variable KEY 5, a value determined by deleting a characteristic string of a file name from the document file URL indicated by the input history data. Specifically, the directory information indicated by the document file URL is set as the value of the variable KEY 5. Subsequently, processing proceeds to S375.

When processing has proceeded to S375, the control section 11 reads from the storage section 19 the default descriptive character string D2 stored in the storage section 19, and writes a document file URL indicated by the input history data into the insertion field of the descriptive character string D2, to thus create a dedicated descriptive character string.

FIG. 8B is a descriptive view showing example processing pertaining to S375. As shown in FIG. 8B, in S375 the document file URL showing history data is written into the insertion field of the descriptive character string D2, thereby creating a message (a dedicated descriptive character string) for describing the type of a search result acquired by a search formula formed from the variable KEY 1 and the variable KEY 5. By settings pertaining to S370, a list—including a data file stored in the same directory where the data file corresponding to the document file URL indicated by the history data is stored—is obtained as a search result. Therefore, a message to this effect is created in S375.

After having completed processing pertaining to S375, the control section 11 proceeds to S380 and sets the descriptive character string generated in connection with S375 in the variable OP. After having performed processing pertaining to S380, the control section 11 generates search request data showing respective values of the set variables KEY 1, KEY 5, and OP (S390). FIG. 9B is a descriptive view showing example generation of search request data pertaining to S390. As shown in FIG. 9B, in S390 NULL values are written or no values are assumed to be written as values of the variables KEY 2 to KEY 4, KEY 6 having not been set through processing pertaining to S370, S380, thereby showing that the search keys corresponding to the variables KEY 2 to KEY 4, KEY 6 are not set in the search request data. Thus, after having completed processing pertaining to S390, the control section 11 inputs the search request data generated in S390 into the queue management module 73 along with the registration command (S395). Subsequently, processing proceeds to S310.

[Printer Event Detection Processing]

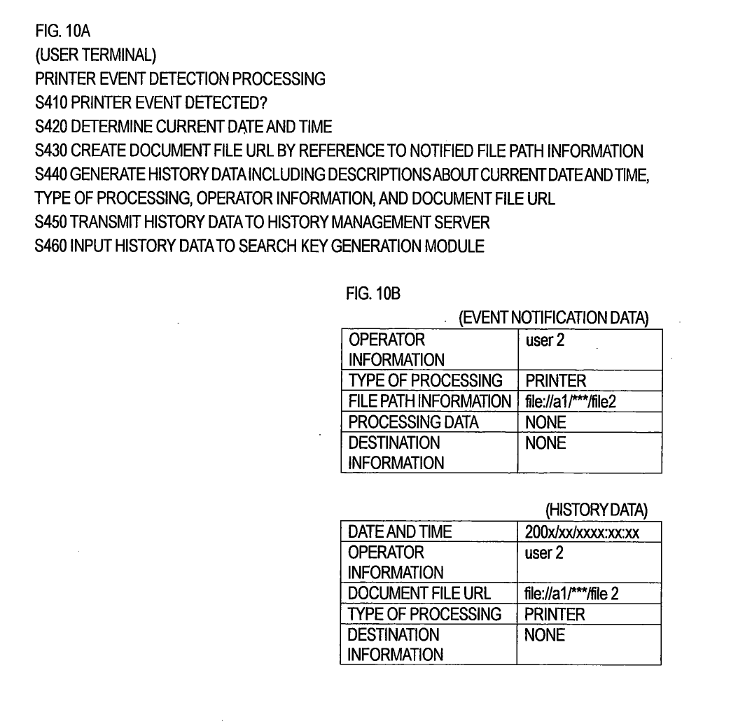

Subsequently, printer event detection processing executed by the control section 11 of the user terminal 10 will be described. FIG. 10A is a flowchart showing printer event detection processing executed by the control section 11. FIG. 10B is a descriptive view showing example generation of history data through printer event detection processing. Printer event detection processing is implemented by the event detection module 77a.

When printer event detection processing is initiated, the control section 11 generates an event related to the printer function of the multifunction machine 30 and remains in a standby condition until event notification data pertaining to this event are received from the multifunction machine 30 (when No is selected in S410). When the event notification data have been received from the multifunction machine 30 via the communications section 17 (when Yes is selected in S410), processing proceeds to S420. The control section 11 selects “Yes” as a determination result in S410 only when having received the event notification data whose information shows a processing type of “printer.”

After having proceeded to S420, the control section 11 identifies the current date and time. Upon completion of processing, the control section 11 generates a document file URL, where the location of the data file (the data file fed to printer processing) indicated by the file path information is written in an URL format, based on the file path information in the event notification data (S430).

Upon completion of processing in S430, the control section 11 generates history data including a description of information showing the above-identified date and time; a description of operator information in the event notification data, the document file URL generated in S430, and information showing the type of processing indicated by the event notification data (a code showing “printer”) (S440).

Upon completion of processing pertaining to S440, the control section 11 inputs the thus-generated history data into the history management server program 85, and transmits the program to the search server 50 via the communications section 17 (S450). At the time of transmission, the registration command is appended to the history data, and the history data are transmitted to the search server 50. Upon completion of processing, the control section 11 inputs the thus-generated history data to the search key generation module 77b (S460) Subsequently, processing proceeds to S410.

[Printer Search Key Generation Processing]

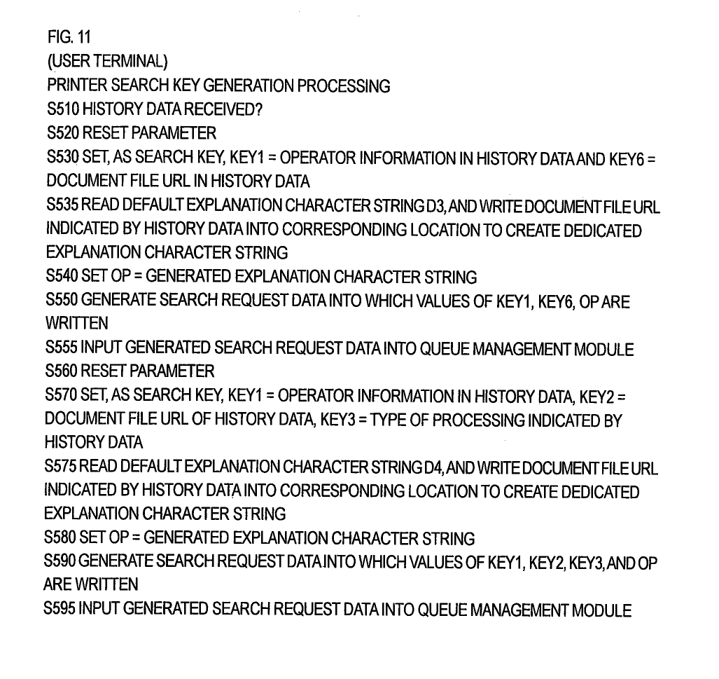

Subsequently, printer search key generation processing performed by the control section 11 of the user terminal 10 will be described. FIG. 11 is a flowchart showing printer search key generation processing performed by the control section 11 of the user terminal 10. This printer search key generation processing is implemented by the search key generation module 77b.

When printer search key generation processing is initiated, the control section 11 remains in a standby condition until history data are input by the event detection module 77a (when No is selected in S510). When the history data are input (when Yes is selected in S510), processing proceeds to S530 after resetting of parameters (KEY 1 to KEY 6, OP) to be used for setting a search key (S520).

When processing has proceeded to S530, the control section 11 sets, as a search key, in the variable KEY 1 a value (an operator ID) showing the operator information in the input history data. The control section 11 also sets in the variable KEY 6 a document file URL showing the input history data. A default explanation character string D3 stored in the storage section 19 is read from the storage section 19, and a document file URL showing history data is written in an insertion field of an explanation character string D3, thereby generating a dedicated explanation character string (S535).

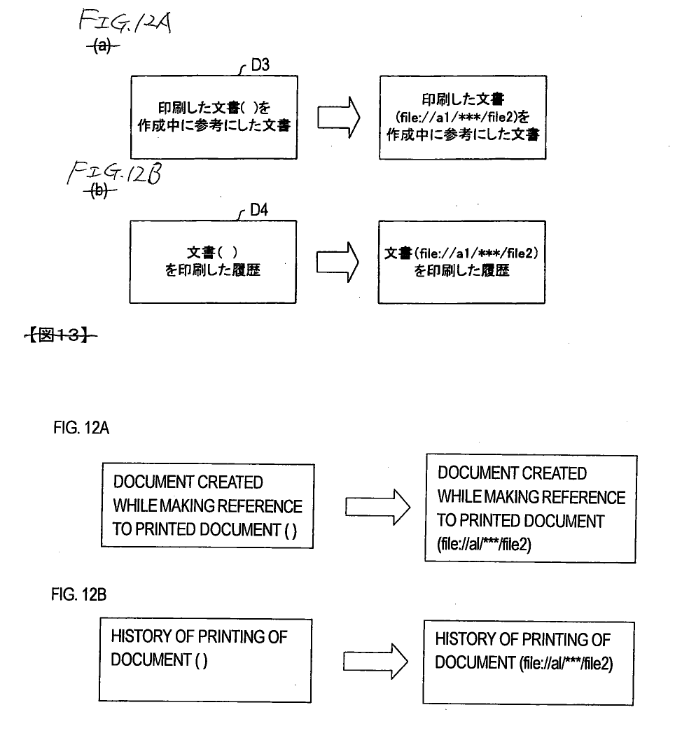

FIG. 12A is a descriptive view showing example processing pertaining to S535. As shown in FIG. 12A, in S535 the document file URL showing history data is written into the insertion field of the explanation character string D3, thereby creating a message (a dedicated explanation character string) for describing the type of a search result acquired by the search formula formed from the variable KEY 1 and the variable KEY 6. By settings pertaining to S530, a list of a data file opened at the same time when the data file corresponding to the document file URL indicated by the history data has been opened is obtained as a search result. Therefore, a message to this effect is created in S535.

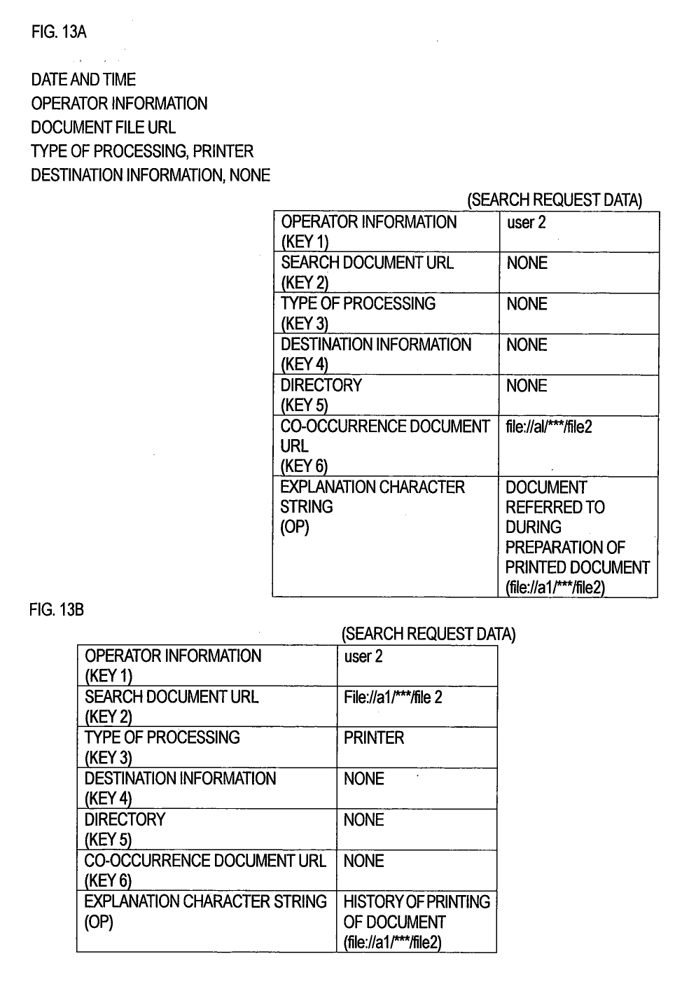

After having completed processing pertaining to S535 in this way, the control section 11 proceeds to processing pertaining to S540, where the explanation character string created in S535 is set in a variable OP. After having completed processing pertaining to S540, the control section 11 generates search request data showing respective values of the set variables KEY 1, KEY 6, and OP (S550) . FIG. 13A is a descriptive view showing example generation of search request data pertaining to S550. As shown in FIG. 13A, in S550, NULL values are described or no values are assumed to be described as values of the variables KEY 2 to KEY 5 having not been set through processing pertaining to S530, S540, thereby showing that the search key corresponding to the variables KEY 2 to KEY 5 is not set in the search request data.

After having completed processing pertaining to S550, the control section 11 inputs the search request data generated in S550 into the queue management module 73 along with a registration command (S555). Subsequently, processing proceeds to S560. When processing has proceeded to S560, the control section 11 proceeds to S570 after having again reset the parameters (KEY 1 to KEY 6, and OP) used for setting a search key. The control section proceeds to S570. After having proceeded to S570, the control section 11 sets, as a search key, a value (an operator ID) indicating operator information in the input history data is set in the variable KEY 1. Further, the control section 11 sets, in the variable KEY 2, the document file URL indicated by the input history data. Moreover, the control section 11 sets, in the variable KEY 3, a value (a code showing “printer” in the present illustrative aspect) indicated by the information about the type of processing of the input history data. Subsequently, processing proceeds to S575.

When processing has proceeded to S575, the control section 11 reads from the storage section 19 the default explanation character string D4 stored in the storage section 19, and writes a document file URL indicated by the input history data into the insertion field of the explanation character string D4, to thus create a dedicated explanation character string.

FIG. 12B is a descriptive view showing example processing pertaining to S575. As shown in FIG. 12B, in S575 the document file URL showing history data is written into the insertion field of an explanation character string D4, thereby creating a message (a dedicated explanation character string) for describing the type of a search result acquired by a search formula formed from the variable KEY 1, the variable KEY 2, and the variable KEY 3. By settings pertaining to S570, a list of dates and times when the data files corresponding to the document file URLs indicated by the history data were printed in the past by the printer function is obtained as a search result. Therefore, a message to this effect is created in S575.

After having completed processing pertaining to S575, the control section 11 proceeds to S580 and sets the explanation character string generated in connection with S575 in the variable OP. After having performed processing pertaining to S580, the control section 11 generates search request data showing respective values of the set variables KEY 1, KEY 2, KEY 3, and OP (S590). FIG. 13B is a descriptive view showing example generation of search request data pertaining to S590. As shown in FIG. 13B, in S590 NULL values are written or no values are assumed to be described as values of the variables KEY 4 to KEY 6, which have not been set through processing pertaining to S570, S580, thereby showing that the search keys corresponding to the variables KEY 4 to KEY 6 are not set in the search request data. Thus, after having completed processing pertaining to S590, the control section 11 inputs the search request data generated in S590 into the queue management module 73 along with the registration command (S595). Subsequently, processing proceeds to S510.

[FAX Machine Event Detection Processing]

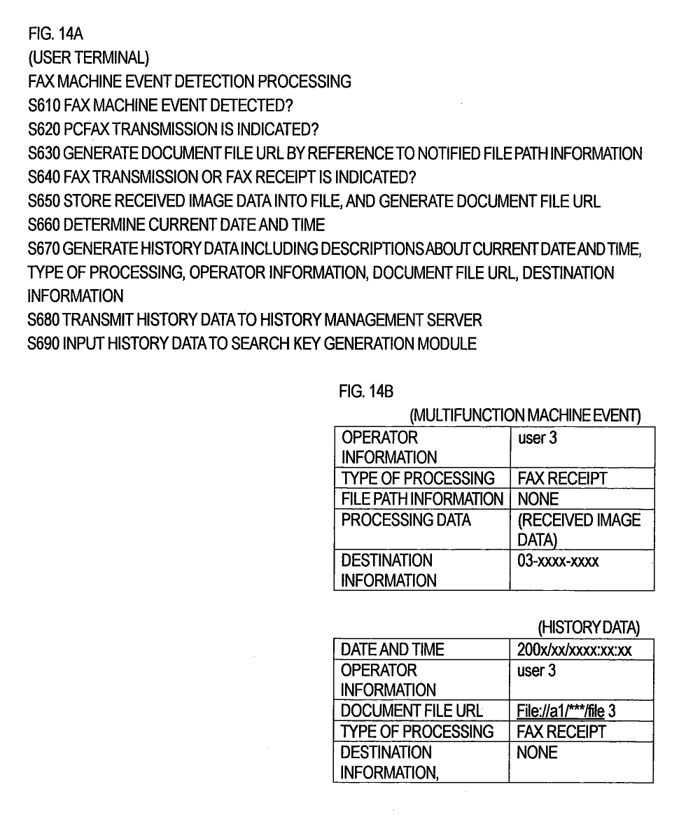

Subsequently, FAX machine event detection processing executed by the control section 11 of the user terminal 10 will be described. FIG. 14A is a flowchart showing FAX machine event detection processing executed by the control section 11 of the user terminal 10. FIG. 14B is a descriptive view showing example generation of history data in FAX machine event detection processing. The FAX machine event detection processing is implemented by the event detection module 79a.

When FAX machine event detection processing is initiated, the control section 11 remains in a standby condition until an event relating to the FAX function or the PCFAX function of the multifunction machine 30 arises and event notification data pertaining to the event is received from the multifunction machine 30 (when No is selected in S610). When the event notification data have been received from the multifunction machine 30 by the communications section 17 (when Yes is selected in S610), processing proceeds to S620. Only upon receipt of event notification data showing that the type of processing is any one of “FAX transmission,” “FAX receipt,” and “PCFAX transmission,” the control section 11 selects Yes as a determination result in S610.

When processing has proceeded to S620, the control section 11 determines whether or not information showing the type of processing included in the received event notification data indicates “PCFAX transmission.” When the information has been determined to indicate “PCFAX transmission” (when Yes is selected in S620), processing proceeds to S630. In contrast, when the information has been determined not to show “PCFAX transmission” (when No is selected in S620), processing proceeds to S640.

When processing has proceeded to S630, the control section 11 generates, file path information in the event notification data, a document file URL where the location of a data file indicated by the file path information (the data file where the transmission data are stored) is written inURL format (S630) Subsequently, processing proceeds to S640.

When processing has proceeded to S640, the control section 11 determines whether or not information showing the type of processing included in the received event notification data indicates “FAX transmission” or “FAX receipt.” When the information has been determined to indicate “FAX transmission” or “FAX receipt” (when Yes is selected in S640), processing proceeds to S650. In contrast, when the information has been determined to show neither “FAX transmission” nor “FAX receipt” (when No is selected in S640), processing proceeds to S610, where the control section 11 remains in a standby condition. The control section 11 stays in a standby condition until the next event arises.

After having proceeded to S650, the control section 11 extracts, from the event notification data, image data (processing data) included in the received event notification data; newly creates a data file including the extracted image data; and stores the data file into the storage section 19. Further, there is created a document file URL where the location of the thus-newly-created data file is written in an URL format. Upon completion of processing pertaining to S650 as mentioned above, the control section 11 proceeds to S660.

After having proceeded to S660, the control section 11 identifies the current date and time. Upon completion of processing, the control section 11 generates history data including a description of information about the identified data and time, a description of operator information in the event detection data, the document file URL generated in S630 or S650, information showing the type of processing included in the event notification data, and a description about the destination information in the event notification data (S670) Upon completion of processing pertaining to S670, the control section 11 inputs the thus-generated history data into the history management server program 85, and transmits the program to the search server 50 via the communications section 17 (S680). At the time of transmission, the registration command is appended to the history data, and the history data are transmitted to the search server 50. Upon completion of processing, the control section 11 inputs the thus-generated history data to the search key generation module 79b (S690) Subsequently, processing proceeds to S610.

[FAX Machine Search Key Generation Processing]

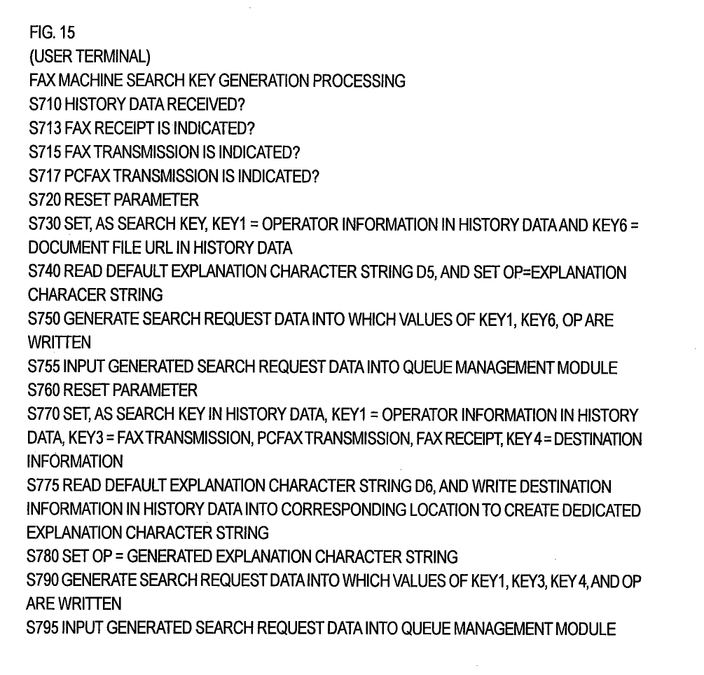

Subsequently, FAX machine search key generation processing performed by the control section 11 of the user terminal 10 will be described. FIG. 15 is a flowchart showing FAX machine search key generation processing performed by the control section 11 of the user terminal 10. This FAX machine search key generation processing is implemented by the search key generation module 79b.

When FAX machine search key generation processing is initiated, the control section 11 remains in a standby condition until history data are input by the event detection module 79a (when No is selected in S710). When the history data are input (when Yes is selected in S710), processing proceeds to S713.

When processing has proceeded to S713, the control section 11 determines whether or not the information showing the type of processing of received event notification data shows “FAX receipt.” When the information has been determined to indicate “FAX receipt” (when Yes is selected in S713) processing proceeds to S760. In contrast, when the information has been determined not to show “FAX receipt” (when No is selected in S713), processing proceeds to S715. When processing has proceeded to S715, the control section 11 determines whether or not the information showing the type of processing of received event notification data shows “FAX transmission.” When the information has been determined to indicate “FAX transmission” (when Yes is selected in S715), processing proceeds to S760. In contrast, when the information has been determined not to show “FAX transmission” (when No is selected in S715), processing proceeds to S717.

When processing has proceeded to S717, the control section 11 determines whether or not the information showing the type of processing of received event notification data shows “PCFAX transmission.” When the information has been determined to indicate “PCFAX transmission” (when Yes is selected in S717), processing proceeds to S720. In contrast, when the information has been determined not to show “PCFAX transmission” (when No is selected in S717), processing proceeds to S710. The control section remains in a standby condition until next history data are input.

When processing has proceeded to S720, the control section 11 resets the parameters (KEY 1 to KEY 6, and OP) used for setting a search key (S720). Subsequently, processing proceeds to S730. After having proceeded to S730, the control section 11 sets, as a search key, a value (an operator ID) indicated by the operator information in the input history data is set in the variable KEY 1. Further, the control section 11 sets, in the variable KEY 6, the document file URL indicated by the input history data. Moreover, an explanation character string D5 stored in the storage section 19 is read from the storage section 19, and the explanation character string D5 is set in the variable OP (S740).

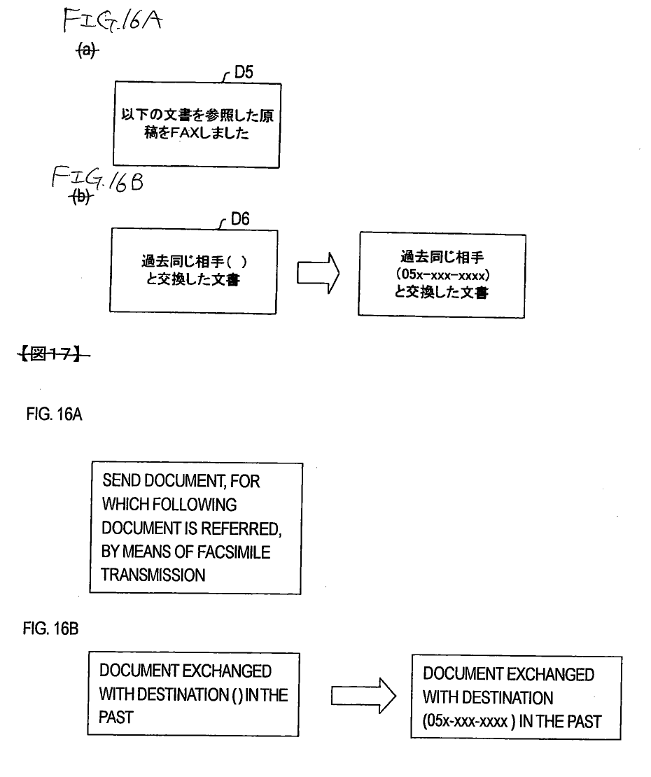

FIG. 16A is a descriptive view showing the explanation character string D5. By settings pertaining to S730, a list of data files opened at the same time when the data file corresponding to the document file URL indicated by the history data has been opened is obtained as a search result. Therefore, a message to this effect is set in the variable OP in S740

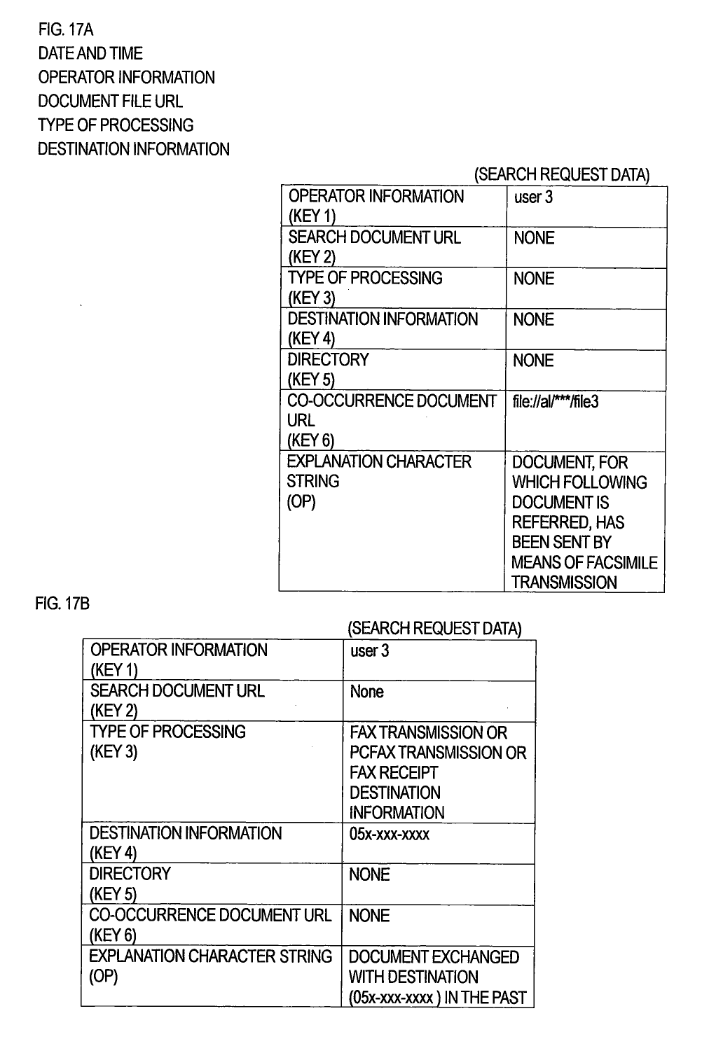

After having performed processing pertaining to S740, the control section 11 generates search request data showing respective values of the set variables KEY 1, KEY 6, and OP (S750). FIG. 17A is a descriptive view showing example generation of search request data pertaining to S750. As shown in FIG. 17A, in S750 NULL values are written or no values are assumed to be described as values of the variables KEY 2 to KEY 5, which have not been set through processing pertaining to S730, S740, there by showing that the search keys corresponding to the variables KEY 2 to KEY 5 are not set in the search request data.

After having completed processing pertaining to S750, the control section 11 inputs the search request data generated in S750 into the queue management module 73 along with the registration command (S755). Subsequently, processing proceeds to S760. When processing has proceeded to S760, the control section 11 proceeds to S770 after having again reset the parameters (KEY 1 to KEY 6, and OP) used for setting a search key. Subsequently, processing proceeds to S770.

After having proceeded to S770, the control section 11 sets, as a search key, a value (an operator ID) indicated by operator information in the input history data, in the variable KEY 1. Further, the control section 11 sets, in the variable KEY 3, a value interconnecting, by a symbol of OR retrieval, a code showing “FAX transmission,” a code showing “FAX receipt,” and a code showing “PCFAX transmission.” A value (phone number) indicated by the destination information in the history data is set in the variable KEY 4. Subsequently, processing proceeds to S775.

When processing has proceeded to S775, the control section 11 reads from the storage section 19 the default explanation character string D6 stored in the storage section 19, and writes a value (phone number) indicated by the destination information in the input history data into the insertion field of an explanation character string D6, to thus create a dedicated explanation character string.

FIG. 16B is a descriptive view showing example processing pertaining to S775. As shown in FIG. 16B, in S775 a value (phone number) indicated by the destination information in the history data is written into the insertion field of the explanation character string D6, thereby creating a message (a dedicated explanation character string) for describing the type of a search result acquired by a search formula formed from the variable KEY 1, the variable KEY 3, and the variable KEY 4. By settings pertaining to S770, a list of documents exchanged with the external terminal devices of the phone calls indicated by the destination information in the history data is obtained as a search result. Therefore, a message to this effect is created in S775.

After having completed processing pertaining to S775, the control section 11 proceeds to S780 and sets the explanation character string generated in connection with S775 in the variable OP. After having performed processing pertaining to S780, the control section 11 generates search request data showing respective values of the set variables KEY 1, KEY 3, KEY 4, and OP (S790). FIG. 17B is a descriptive view showing example generation of search request data pertaining to S790. As shown in FIG. 17B, in S790 NULL values are written or no values are assumed to be described as values of the variables KEY 2, KEY 5, and KEY 6, which have not been set through processing pertaining to S770, S780, thereby showing that the search keys corresponding to the variables KEY 2, KEY 5, and KEY 6 are not set in the search request data. Thus, after having completed processing pertaining to S790, the control section 11 inputs the search request data generated in S790 into the queue management module 73 along with the registration command (S795) Subsequently, processing proceeds to S710.

[Queue Management Module Processing]

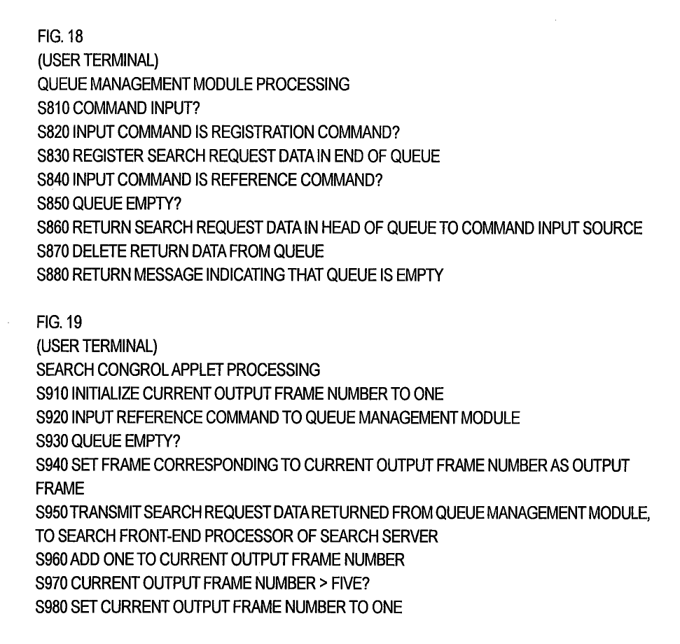

Next will be described processing to be performed by the control section 11 of the user terminal 10. FIG. 18 is a flowchart showing queue management module processing to be performed by the control section 11. The document file event detection processing is implemented by the queue management module 73. The queue management module processing is implemented by the queue management module 73.

When the queue management module processing is initiated, the control section 11 remains in a standby condition until a command is input in S810. When a command has been input (when Yes is selected in S810), processing proceeds to S820. The command to be input includes the registration command and the reference command. The registration command is input by the search key generation modules 75b, 77b, and 79b along with the search request data, and the reference command is input via the search control applet 71b.

When processing has proceeded to S820, the control section 11 determines whether or not the input command is the registration command. When the input command has been determined to be a registration command (when Yes is selected in S820), processing proceeds to S830. The search request data input along with the registration command are registered in the end of the search control queue 19a. Subsequently, the control section 11 proceeds to S810, and remains in a standby condition until the next input.

When the control section 11 has determined that the input command is not the registration command (when No is selected in S820), processing proceeds to S840, where a determination is made as to whether or not the input command is the reference command. When the input command has been determined to be the reference command (when Yes is selected in S840), a determination is made as to whether or not the search control queue 19a is empty (i.e., no search request data are registered) (S850).

When the search control queue 19a is determined not to be empty (i.e., the search request data are registered in the search control queue 19a) (when No is selected in S850), the control section 11 returns the search request data stored in the head of the search control queue 91a to the source of input of the reference command (S860). The search request data returned to the source of input of the reference command are deleted from the search control queue 19a (S870). Subsequently, the control section 11 proceeds to S810.

Meanwhile, when having determined that the search control queue 19a is empty (when Yes is selected in S850), the control section 11 returns to the source of input of the reference command data showing that the search control queue 19a is empty (S880), and subsequently proceeds to S810. In addition, upon having determined that the input command is not the reference command (when No is selected in S840), the control section 11 proceeds to S810 without performing processing pertaining to S850 to S880, and the control section 11 remains in a standby condition until the next input.

[Search Control Applet Processing]

Search control applet processing to be performed by the control section 11 of the user terminal 10 will now be described. FIG. 19 is a flowchart showing search control applet processing to be performed by the control section 11. The search control applet processing is implemented by the search control applet 71b.

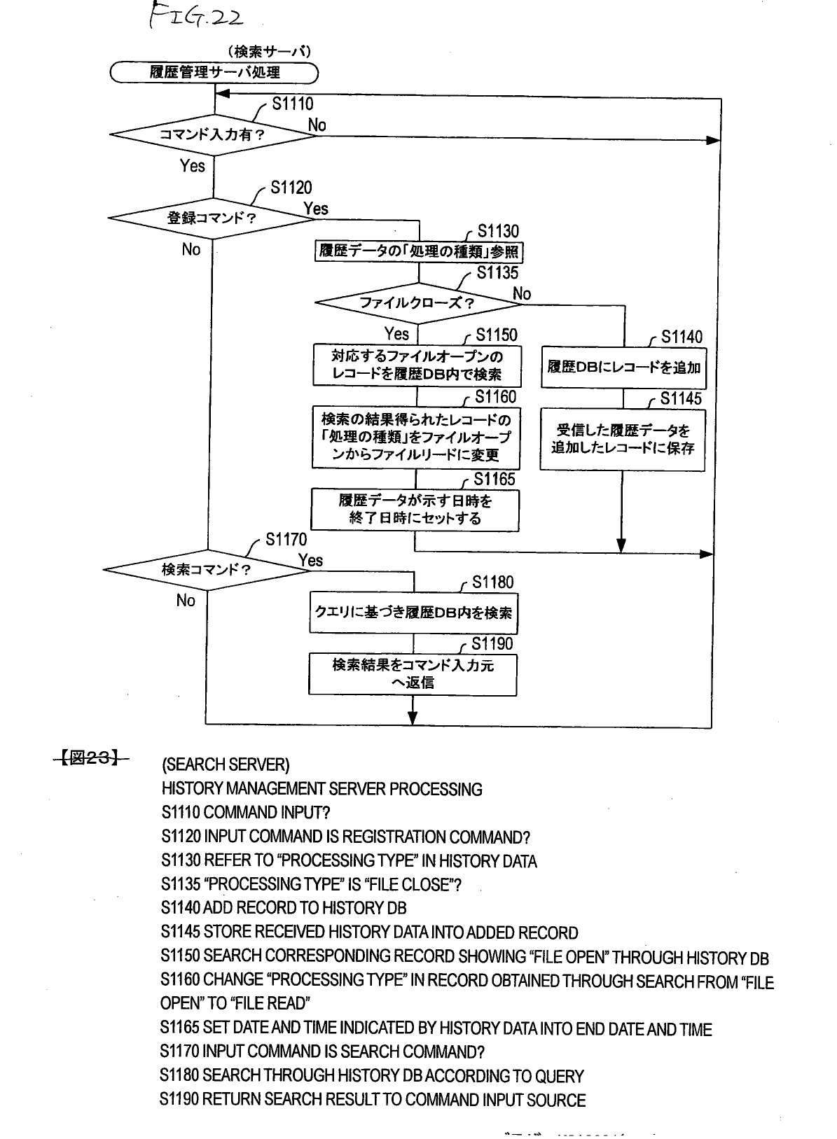

When search control applet processing is initiated, the control section 11 first initializes a current output frame number to a value of “1” (S910). When a search result is displayed on the search result display screen of the web browser 71 divided into a plurality of frames (see FIG. 21), the current output frame number is used for switching a frame on which the search result is displayed. Respective frames constituting the search result display screen are sequentially assigned frame numbers from frames in the topmost row in the search result display screen. The current output frame number represents a frame number assigned to any one of the plurality of frames constituting the search result display screen.

After completion of initialization of such a current output frame number, the control section 11 proceeds to S920, where a reference command requiring a reference to the search control queue 19a is input to the queue management module 73, thereby acquiring return data from the queue management module 73 in response to the reference command. Upon acquisition of the return data form the queue management module 73, processing proceeds to S930, where a determination is made as to whether or not the return data from the queue management module 73 show that the search control queue 19a is empty. When the return data are determined to show that the search control queue 19a is empty (when Yes is selected in S930), processing proceeds to S920, where the reference command is again input to the queue management module 73.

Meanwhile, when the control section 11 has determined, in S930, that the return data from the queue management module 73 are search request data (when No is selected in S930), processing proceeds to S940. A frame assigned the same number as the current output frame number is set in a frame (output frame) used for displaying response data from the search server 50 in response to the search request data acquired from the queue management module 73. Upon completion of processing, the control section 11 inputs, into the search front-end processor 81, the search request data acquired as return data from the queue management module 73; and transmits the search request data to the search server 50 (S950).

After having completed processing pertaining to S950, the control section 11 adds a value of one to the current output frame number, to thus update the current output frame number (S960). A determination is made as to whether or not the updated current output frame number is greater than a value of five (S970). When the updated current output frame number is determined to be greater than a value of five (when Yes is selected in S970), the current output frame number is reset to a value of one (S980). Subsequently, processing proceeds to S920. Meanwhile, when the updated current output frame number is a value of five or less (when No is selected in S970), the control section 11 proceeds to S920 without performing processing pertaining to S980. Thus, the control section 11 sequentially transmits to the search server 50 search request data registered in the search control queue 19a while setting the output frame of the response data so as to be switched.

[Display Control Module Processing]

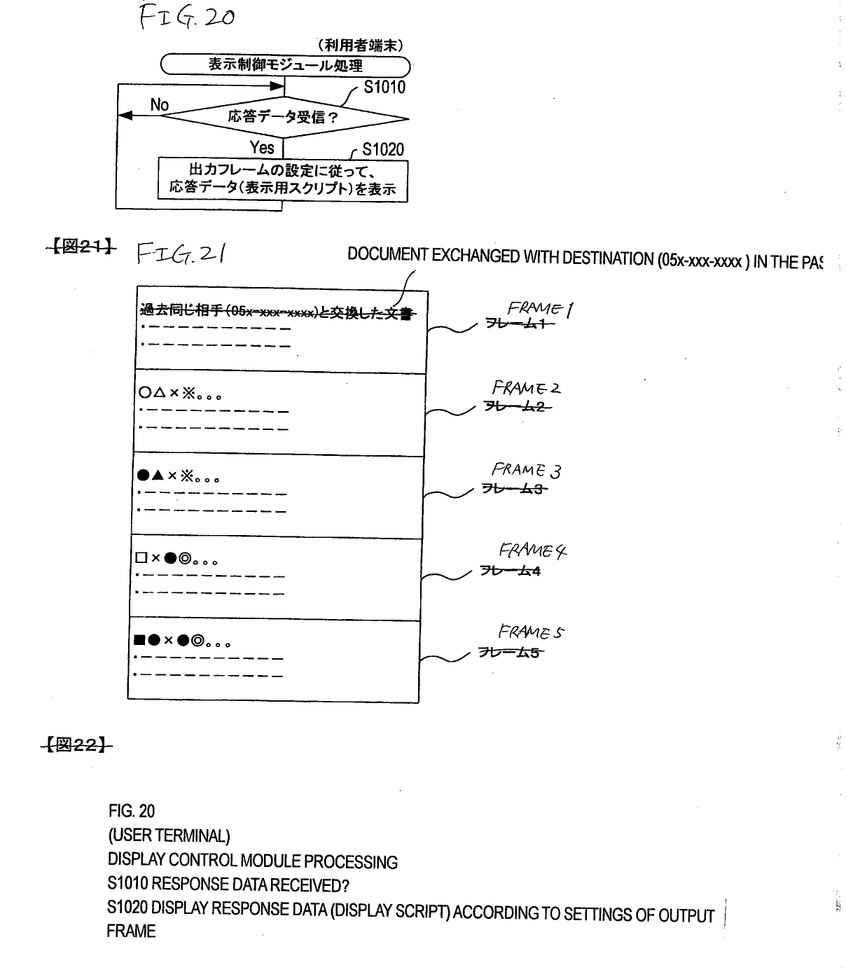

Display control module processing to be performed by the control section 11 of the user terminal 10 will now be described. FIG. 20 is a flowchart showing display control module processing to be performed by the control section 11. The display control module processing is implemented by the display control module 71a. FIG. 21 is a descriptive view showing the configuration of a search result display screen.

When display control module processing is initiated, the control section 11 remains in a standby condition until response data in answer to the search request data from the search server 50 is received via the communications section 17 (S1010) Upon receipt of the response data (when Yes is selected in S1010), processing proceeds to S1020. After having proceeded to S1020, the control section 11 displays a screen originating from the response data in the output frame set by the search control applet 71b. Subsequently, processing proceeds to S1010.

When processing pertaining to S1020 is first performed after initiation of display control module processing, the control section 11 displays, as preprocessing, on the display section 15 a search result display screen formed from a plurality of frames. FIG. 21 is a descriptive view showing the configuration of a search result display screen to be displayed on the display section 15 by the control section 11. As shown in FIG. 21, the search result display screen has a plurality of (specifically, five) frames.

During the display control module processing, the control section 11 receives a display script from the search server 50 as data in response to the search request data, wherein the display script is a script for display purpose (an HTML document) including itemized descriptions about the date and time and the document file URL, both being indicated by a record (history data) extracted from the history database 55a in accordance with the search formula indicated by the search request data, and a description about the value (a message showing the type of the search result) of the variable OP indicated by the search request data. The control section 11 comprehends the display script, and displays on the set frame an image showing a data list including the date and time and the document file URL, both being indicated by the extracted record (history data), and the message. Namely, the control section 11 displays, as a search result, the data list of relevant documents including dates and times and document file URLs in the frame, as well as displaying a message describing the type of the search result in this frame.

[History Management Server Processing]

Incidentally, the history data transmitted from the event detection modules 75a, 77a, 79a of the user terminal 10 to the search server 50 are received by history management server processing performed by the search server 50. FIG. 22 is a flowchart showing history management server processing performed by the control section 51 of the search server 50. The history management server processing is implemented by the history management server program 85.

When history management server processing is initiated, the control section 51 remains, in S1110, in a standby condition until a command is input. When a command has been input (when Yes is selected in S1110), processing proceeds to S1120. The command to be input may be a registration command or a search command. The registration command is input by the event detection modules 75a, 77a, and 79a along with history data via the communications section 53, and the search command is input by the search engine 83.

When having proceeded to S1120, the control section 51 determines whether or not the input command is the registration command. Upon having determined that the input command is the registration command (when Yes is selected in S1120), the control section 51 refers to information showing the type of processing belonging to the history data input along with the registration command (S1130), thereby determining whether or not the information showing the type of processing is “file close” (S1135). The history data, in which information showing the type of processing indicates “file close,” correspond to history data generated when the close event of the data file has arisen.

When having determined that the information showing the type of processing does not indicate “file close” in S1135 (when No is selected in S1135), the control section 51 generates a new record in the history database 55a (S1140). Further, the control section 51 writes, in respective fields corresponding to the record, a value matching the value indicatedby the history data input along with the registration command, thereby registering into the history database 55a the history data input by the event detection modules 75a, 77a, and 79a (S1145).

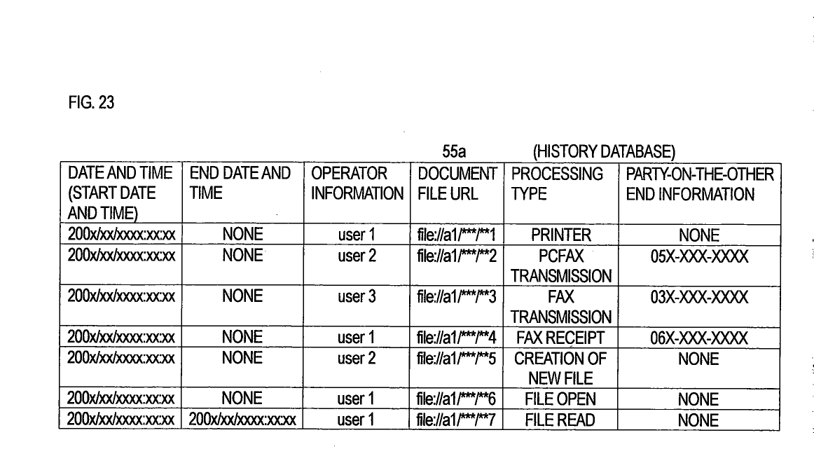

FIG. 23 is a descriptive view showing the configuration of the history database 55a. As shown in FIG. 23, the history database 55a has, in each record, a “start date and time” field, an “end date and time” field, an “operator information” field, a “document file URL” field, a “processing type” field, and a “destination information” field.

Specifically, in S1145, the control section 51 writes information about a date and time belonging to history data into a “start date and time” field of a new record; writes operator information belonging to the history data into the “operator information” field; writes a document file URL indicated by history data in to a “document file URL” field; writes information showing the type of processing belonging to the history data into the “processing type” field; and writes information about a destination belonging to the history data into the “destination information” field. In S1145, the “end date and time” field is made empty, and editing of the record is completed. When the history data have been registered in the history database 55a in this way, the control section 51 proceeds to S1110, where the control section 51 remains in a standby condition until the next command is input.

Meanwhile, when having determined that the information showing the type of processing indicates “file close” in S1135 (when Yes is selected in S1135), the control section 51 proceeds to S1150, where there is performed a search for the record of an open event corresponding to the close event (i.e., a data file open event having arisen prior to the close event) across the history database 55a. Specifically, across the history database 55a there is performed a search for a record whose “processing type” field shows an “open file” and where operator information, the document file URL, and destination information indicate the same value as that of the input history data.

Upon completion of processing in S1150, the control section 51 rewrites the value of “processing type” field in the record obtained as a result of the search, from the code showing “file open” into a code showing “file read” (S1160). Information about a date and time belonging to the input history data is written into the “end date and time” field in the record obtained as a result of the search (S1165). After processing pertaining to S1165 has been completed, processing proceeds to S1110, where the control section 51 remains in a standby condition until input of the next command.

In addition, when having determined, in S1120, that the input command is not the registration command (when No is selected in S1120), the control section 51 determines whether or not the input command is the search command (S1170). When the input command has been determined not to be the search command (when No is selected in S1170), processing proceeds to S1110. In contrast, when the input command has been determined to be the search command, processing proceeds to S1180.

When having proceeded to S1180, the control section 51 extracts from the history database 55a the record matching the search formula in accordance with the search formula indicated by the query input (by the search engine 83) along with the search command. Upon completion of processing, the control section 51 inputs the extracted record to the source of input of the search command (i.e., the search engine 83) as data in response to the query (S1190). When a record matching the search formula cannot be extracted at all in S1180, the control section 51 inputs the return data showing “No Search Result” to the source of input of the search command (i.e., the search engine 83) as data in response to the query (S1190). Subsequently, the control section 51 proceeds to S1110.

[Search Front-end Processor Processing]

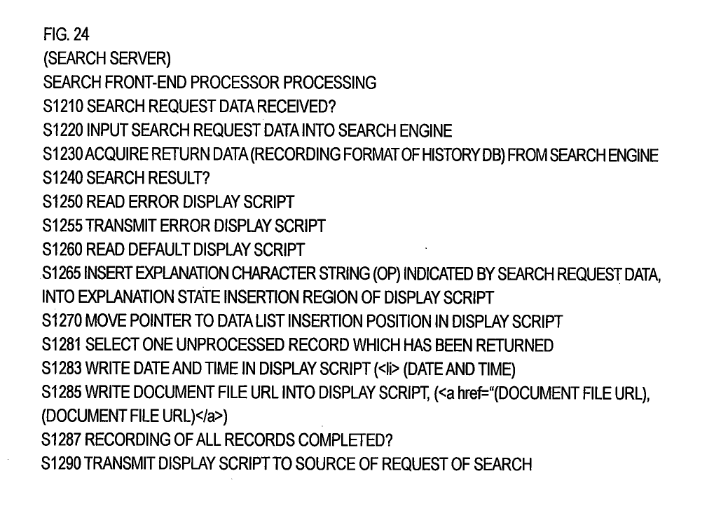

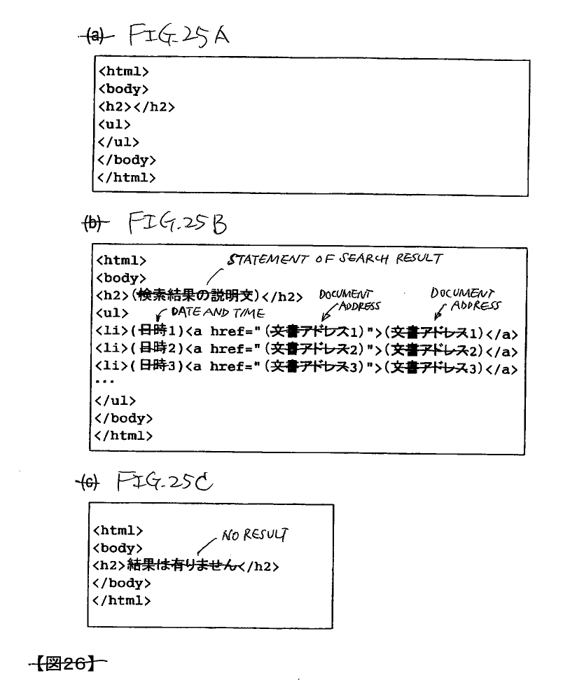

There will now be described search front-end processor processing performed by the control section 51 of the search server 51. FIG. 24 is a flowchart showing search front-end processor processing performed by the control section 51. The search front-end processor processing is implemented by the search front-end processor 81. FIG. 25 is a descriptive view showing the configuration of a display script generated by search front-end processor processing.

When search front-end processor processing is initiated, the control section 51 remains in a standby condition until search request data from the user terminal 10 (the search control applet 71b) are received via the communications section 53 (S1210). Upon receipt of the search request data (when Yes is selected in S1210), the control section inputs the thus-received search request data to the search engine 83 (S1220) After having completed processing pertaining to S1220, the control section proceeds to S1230, where the control section obtains from the search engine 83 data in response to the search request data. As will be described in detail later, the search engine 83 is configured so as to generate, upon receipt of an input of search request data, a query corresponding to the search request data; input the query to the history management server program 85; and transfer the return data from the history management server program 85 to the search front-end processor 81. In S1230, the control section 51 receives return data of this type.

Upon receipt of return data in response to the search request data from the search engine 83, the control section 51 proceeds to S1240, to thus determine whether or not the return data include the record extracted from the history database 55a in accordance with the query. Thus, a determination is made as to whether or not the return data correspond to a search result in response to the search request data. When the record is not included in the return data, information showing that “No search result” is included in the return data. Accordingly, when having acquired from the search engine 83 the return data including the information showing “No search result,” the control section 51 determines that there is no search result (when No is selected in S1240).

When the search result is determined not to be present (when No is selected in S1240), the control section 51 reads from the storage section 55 an error display script, which has been stored in the storage section 55 in advance and has a configuration shown in FIG. 25C (S1250) . FIG. 25C is a descriptive view showing the configuration of the error display script.

The thus-read error display script is transmitted to the user terminal 10 (i.e., the display control module 71a), which is the source of transmission of the search request data, as data in response to the search request data sent by the user terminal 10 (i.e., the search control applet 71b), via the communications section 53 (S1255). Subsequently, the control section 51 proceeds to S1210, where the control section remains in a standby condition until the next search request data are received.

When the search result is determined to be present in S1240 (when Yes is selected in S1240), the control section 51 reads, from the storage section 55, a default display script (a template), which has been stored in advance in the storage section 55 and has a configuration shown in FIG. 25A (S1260) FIG. 25A is a descriptive view showing the configuration of the default display script.

After having completed processing pertaining to S1260, the control section 51 proceeds to S1265, where an explanation character string (the value of a variable OP) belonging to the received search request data is inserted into an explanation statement insertion field of the read display script. Specifically, the explanation character string is inserted between tags <h2></h2> shown in FIG. 25A.

After having completed processing pertaining to S1265, the control section 51 proceeds to S1270, where a pointer is shifted to a data list insertion position (immediately after a tag <ul>) in the display script into, which the explanation character string has been inserted. After completion of processing, processing proceeds to S1281.

Upon proceeding to S1281, the control section 51 selects a unprocessed record as one object of processing from among the group of records input by the search engine 83 and stored in the return data, and writes into the display script the start date and time indicated by the record selected as an object of processing (S1283). Specifically, a character string—having a tag <li>, which indicates itemization and is affixed with the value of the start date and time—is inserted into the display script (S1283).

Upon completion of processing, the control section 51 proceeds to S1285, and a document file URL indicated by the record to be processed is written into the display script so as to be added to the end of the character string inserted in S1283. Specifically, the document file URL indicated by the record to be processed is inserted into the display script in the form of <A HREF=“(Document File URL)”>(Document File URL)</A> by use of a link tag.

Upon completion of processing, the control section 51 proceeds to S1287, where a determination is made as to whether or not all of the records stored in the return data have been selected as objects of processing in S1281. When a determination is made that not all of the records have been selected (when No is selected in S1287), processing proceeds to S1281, where unselected records are selected as objects of processing.

Meanwhile, when having determined that all of the records stored in the return data have been selected as objects of processing in S1281 (when yes is selected in S1287), the control section 51 proceeds to S1290 and transmits, to the source device of transmission of the search request data (i.e., the user terminal 10) via the communications section 53, the display script created as mentioned above (i.e., a display script including an itemized description of information about the start date and time and the document file URL, both being indicated by the explanation character string and the record matching the search formula indicated by the search request data). Subsequently, the control section 51 proceeds to S1210, and remains in a standby condition until the next search request data are received.

[Search Engine Processing]

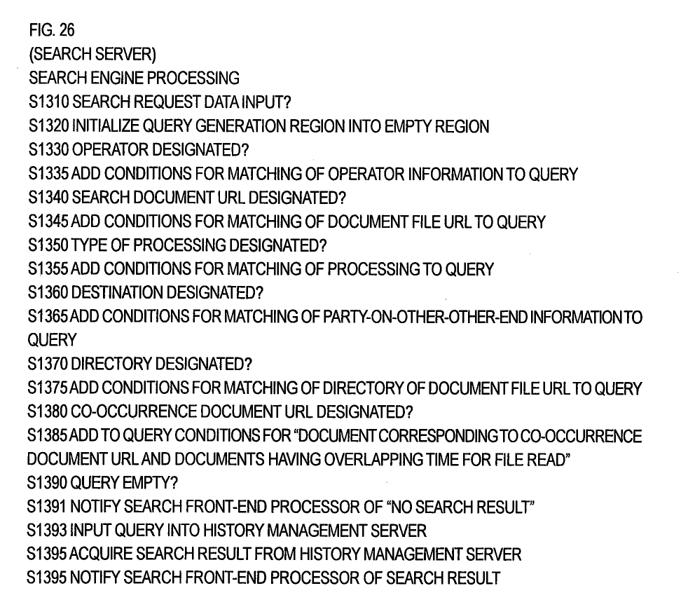

Search engine processing performed by the control section 51 of the search server 50 will now be described. FIG. 26 is a flowchart showing search engine processing performed by the control section 51. Search engine processing is implemented by the search engine 83.

When search engine processing is initiated, the control section 51 remains in a standby condition until search request data from the search front-end processor 81 are input (S1310). Upon receipt of an input of search request data (when Yes is selected in S1310), the control section 51 initializes a query generation region ensured in the memory (S1320).

Upon completion of processing, the control section 51 proceeds to S1330, and determines whether or not an “operator information” search key is set in the input search request data. Specifically, a determination is made as to whether or not an effective value (exclusive of a NULL value) is set in the variable KEY 1. When the “Operator Information” search key is determined to not be set (when No is selected in S1330), processing proceeds to S1340.

Meanwhile, when the “Operator Information” search key is determined to be set (when Yes is selected in S1330), the control section 51 registers, in the query generation region, a character string (e.g., “KEY 1”=(value)) used for taking, as an object of search, a record in the history database 55a where the operator information matches the value of the variable KEY 1 (S1335). Subsequently, processing proceeds to S1340.

Upon proceeding to S1340, the control section 51 determines whether or not a search key for a “Search Document URL” is set in the input search request data. Namely, a determination is made as to whether or not an effective value (exclusive of a NULL value) is set in the variable KEY 2. When the search key for the “Search Document URL” is determined to not be set (when No is selected in S1340), processing proceeds to S1350.

When the search key for “Search Document URL” is determined to be set (when Yes is selected in S1340), the control section 51 registers, in the query generation region, a character string (e.g., “KEY 2”=(value)) used for taking, as an object of search, a record in the history database 55a where the document file URL matches the value of the variable KEY 2 (S1345), and subsequently proceeds to S1350. When a character string used for taking a record of another type as an object of search has already been registered in the query generation region, an AND symbol is affixed to the end of the registered character string. Subsequently, the character string used for taking, as an object of search, a record in the history database 55a—where the document file URL matches the value of the variable KEY 2—is registered in the query generation area, and the like. Thus, a search formula for AND search purpose is created in the query generation region. Specifically, there is created a search formula used for extracting, from the history database 55a, records, which match all objects of search represented by the respective character strings registered in the query generation area.

Upon proceeding to S1350, the control section 51 determines whether or not the search key of “Processing Type” is set in the input search request data. Specifically, a determination is made as to whether or not an effective value (exclusive of a NULL value) is set in the variable KEY 3. When the search key of “Processing Type” is determined to not be set (when No is selected in S1350), processing proceeds to S1360.

When the search key for “Processing Type” is determined to be set (when Yes is selected in S1350), the control section 51 registers, in the query generation region, a character string (e.g., “KEY 3”=(value)) used for taking, as an object of search, a record in the history database 55a where information showing the type of processing matches the value of the variable KEY 3 (S1355), and subsequently proceeds to Sl360. When a character string used for taking a record of another type as an object of search has already been registered in the query generation region, an AND symbol is affixed to the end of the registered character string. Subsequently, the character string used for taking, as an object of search, a record in the history database 55a—where the information showing the type of processing matches the value of the variable KEY 3—is registered in the query generation area, and the like. Thus, a search formula for AND search purpose is created in the query generation region.

Upon proceeding to S1360, the control section 51 determines whether or not the search key of “Destination Information” is set in the input search request data. Specifically, a determination is made as to whether or not an effective value (exclusive of a NULL value) is set in the variable KEY 4. When the search key of “Destination Information” is determined to not be set (when No is selected in S1360), processing proceeds to S1370.

When the search key for “Destination Information” is determined to be set (when Yes is selected in S1360), the control section 51 registers, in the query generation region, a character string (e.g., “KEY 4”=(value)) used for taking, as an object of search, a record in the history database 55a where information about the other destination matches the value of the variable KEY 4 (S1365), and subsequently proceeds to S1370. When a character string used for taking a record of another type as an object of search has already been registered in the query generation region, an AND symbol is affixed to the end of the registered character string. Subsequently, the character string used for taking, as an object of search, a record in the history database 55a—where the information showing the type of processing matches the value of the variable KEY 4—is registered in the query generation area, and the like. Thus, a search formula for AND search purpose is created in the query generation region.

Upon proceeding to S1370, the control section 51 determines whether or not the search key of “Directory” is set in the input search request data. Specifically, a determination is made as to whether or not an effective value (exclusive of a NULL value) is set in the variable KEY 5. When the search key of “Directory” is determined to not be set (when No is selected in S1370), processing proceeds to S1380.

When the search key for “Director” is determined to be set (when Yes is selected in S1370), the control section 51 registers, in the query generation region, a character string (e.g., “KEY 5”=(value)) used for taking, as an object of search, a record in the history database 55a in which the name of a directory-where there is stored the data file indicated by the document file URL (in other words, a character string exclusive of the file name indicated by the document file URL)—matches the value of the variable KEY 5 (S1375), and subsequently proceeds to S1380. When a character string used for taking a record of another type as an object of search has already been registered in the query generation region, an AND symbol is affixed to the end of the registered character string. Subsequently, the character string used for taking, as an object of search, a record in the history database 55a—where the information showing directory information matches the value of the variable KEY 5—is registered in the query generation area,and the like. Thus, a search formula for AND search purpose is created in the query generation region.

In addition, upon proceeding to S1380, the control section 51 determines whether or not the search key of “Co-occurrence Document URL” is set in the input search request data. Specifically, a determination is made as to whether or not an effective value (exclusive of a NULL value) is set in the variable KEY 6. When the search key of “Co-occurrence Document URL” is determined to not be set (when No is selected in S1380), processing proceeds to S1390.

When the search key for “Co-occurrence Document URL” is determined to be set (when Yes is selected in S1380), the control section 51 registers, in the query generation region, a character string (e.g., “KEY 6”=(value)) used for taking, as an object of search, a record about the data file, which has been read at the same time when the data file designated by the URL indicated by the variable KEY 6 (S1385) was opened, and subsequently proceeds to S1390.

When a character string used for taking a record of another type as an object of search has already been registered in the query generation region, an AND symbol is affixed to the end of the registered character string. Subsequently, the character string used for taking, as an object of search, a record in the history database 55a pertaining to the data file-which has been read at the same time when the data file designated by the URL indicated by the variable KEY 6 was opened-is registered in the query generation area, and the like. Thus, a search formula for AND search purpose is created in the query generation region.

Upon proceeding to S1390, the control section 51 determines whether or not the query generation region is empty (i.e., whether or not a character string is registered). When the query generation region is determined to be empty (when No is selected in S1390), return data showing “No search result” are input into the search front-end processor 81 belonging to the source of input of search request data as return data in response to the search request data (S1391). Subsequently, the control section 51 proceeds to S1310, and remains in a standby condition until the next search request data are input.

Meanwhile, when the query generation region is determined to not be empty (when No is selected in S1390), the control section 51 proceeds to S1393. The query including the search command is input to the history management server program 85, and return data are acquired from the history management server program 85 (S1395). The return data are input to the search front-end processor 81, which is the source of input of search request data, as return data in response to the search request data (S1397). Subsequently, the control section 51 proceeds to S1310, and remains in a standby condition until the next search request data are input.

Through above-described processing, the control section 51 provides the search front-end processor 81 with the return data including the record in the history database 55a matching the search formula indicated by the query. As above, when the object of search indicated by the query is plural, the search front-end processor 81 is provided with a record in the history database 55a corresponding to all of objects of search, by an AND search.

[Advantages]

The retrieval system 1 of the present illustrative aspect has been described. However, the user terminal 10 of this retrieval system 1 sets a search key corresponding to the multifunction machine 30 or processing specifics of the OS, based on the history data showing specifics of processing performed by the multifunction machine 30 and the history data showing details of a file event, by the search key generation modules 75b, 77b, and 79b. At that time, there is created a message (an explanation character string), which corresponds to processing specifics and describes the type of a search result corresponding to the search key. This message is transmitted as search request data to the search server 50 along with the search key.

Meanwhile, the search server 50 generates, as a display script showing a result of a search conducted according to the search key, a display script including: an itemized description of information about the start dates and times and document file URLs indicated by the respective records extracted from the history database 55a as a result of a search having been conducted according to the search key; and having a message transmitted as search request data from the user terminal 10. This display script is transmitted to the user terminal 10. Further, based on the display script, the user terminal 10 displays, on the display section 15, a search result corresponding to the search key and a message showing the type of a search result, based on the search script.

As above, in the search system 1 of the present illustrative aspect, a message showing a search result is displayed for the user in conjunction with the search result. Accordingly, the user can readily ascertain the type of processing by which there has been set a search key being compatible with a data list (a data list formed from information including a date and time and a document file URL) indicated by the search result (in other words: the type of processing related to the data list)

In the present illustrative aspect, the message generated during setting of the search key is transmitted from the user terminal 10 to the search server 50 along with the search key. A display script including a search result and a message is transmitted from the search server 50 to the user terminal 10. Accordingly, the user terminal 10 does not need to manage the message by itself. Specifically, in the present illustrative aspect, the user terminal 10 does not need to make the search result associated with the message, and hence processing pertaining to the display of a message on the user terminal 10 is simple.

Moreover, in the illustrative aspect, the user terminal 10 generates history data showing specifics of processing performed by the multifunction machine 30 and the history data showing specifics of a file event by the event detection modules 75a, 77a, and 79a; and transmits the thus-generated history data to the search server 50. The search server 50 receives the history data transmitted from the user terminal 10, and registers the thus-received history data into the history database 55a.

Specifically, in the present illustrative aspect, data showing details of processing performed in the past in the user terminal 10 or the multifunction machine 30 are registered in the history database 55a. A data list (the history of performance in the past) corresponding to processing performed by the multifunction machine 30 or the OS according to the user's operation is provided to the user based on the information about the history database 55a.

Accordingly, when the user has used the retrieval system 1, a list of data relevant to the processing, which has been performed this time by use of the user terminal 10 or the like, is acquired from the search server 50. Further, the type of a search result (a data list) can be comprehended based on a message. This saves users the trouble of ascertaining the type of data list to which the search result corresponds. In other words, in the present illustrative aspect, a data list showing the history of performance of processing based on the user's operation can be provided to the user in a meaningful manner. Accordingly, the search system 1 is very convenient to the user.

In the present illustrative aspect, data including a description about a URL (the address of a location where data are to be stored) of a data file—where data handled in corresponding processing are stored—are generated as history data. The thus-generated history data are registered in the history data base 55a. A display script including a description about this URL is generated as a search result, and a URL of the data handled in processing of the past is provided for the user. Accordingly, the user can readily understand the location of the relevant data handled in the past, and can easily make a reference to the relevant data.

In the present illustrative aspect, data including a description of an URL of a data file having the data handled in corresponding processing and a description of a processing date and time are generated as history data. The data are registered in the history database 55a. A display script including the description of the processing date and time and the description of the URL is generated as a search result. A processing date and time of the past is provided to the user along with the URL of the data file. Consequently, according to this retrieval system 1, the user can readily understand the time of the past and the nature of relevant data handled at that time. Further, the above message display is very useful for the user when the user has such understandings.

In the present illustrative aspect, information showing the type of processing is appended to the history data, and the information is registered in the history database 55a. A display script including a description about a processing date and time, a description about the type of processing, and a description about the URL is generated as a search result. The type of processing performed in the past, the URL of the data file, and the processing date and time are provided to the user. Consequently, according to the search system 1, the user can acquire, from the search server 50, a list of data handled through processing, which is of the same type as that processing having triggered the searched. In gaining the understand of the list, the user can make a reference to the message and, therefore, can readily understand details of the list.

The search server 50 of the present illustrative aspect corresponds to a search server, and a system formed from the user terminal 10 and the multifunction machine 30 corresponds to an information processing system. The user terminal 10 corresponds to a communication device, and the multifunction machine 30 corresponds to a processing execution device.

The communications section 17 corresponds to a first communication unit. A processing execution unit is embodied by processing (FIG. 4) pertaining to S140 executed by the control section 31 of the multifunction machine 30. A generation unit is implemented by search key generation processing (FIGS. 11 and 15) executed by the control section 11 of the user terminal 10. A search request unit is implemented by search control applet processing (FIG. 19) executed by the control section 11. A display control unit is implemented by display control module processing (FIG. 20) executed by the control section 11. A history transmission unit is implemented by the event detection processing (FIGS. 10 and 14) executed by the control section 11.

The communications section 53 corresponds to a second communication unit, and the history database 55a corresponds to a database. A registration unit is implemented by processing pertaining to S1130 to S1165 (FIG. 22) in history management server processing executed by the control section 51 of the search server 50. A data extraction unit is implemented by processing pertaining to S1170 to S1190 executed by the control section 51 and search engine processing (FIG. 26). A display data generation unit is implemented by processing pertaining to S1230 to S1287 (FIG. 24) in search front-end processor processing executed by the control section 51, and a response unit is implemented by processing in S1290 executed by the control section 51.

[Other Illustrative Aspects]

The present invention is not limited to the above illustrative aspect and can assume various modes. For instance, in the present illustrative aspect, the search result display screen is divided into a plurality of frames, and a plurality of search results are displayed simultaneously. However, the retrieval system 1 may also be configured such that the search result display screen is formed as a single frame and such that search results are sequentially switched and displayed on the search result display screen.

In the present illustrative aspect, in relation to processing pertaining to file operation and processing executed by the multifunction machine 30, the history data showing processing specifics are registered in the history database 55a. The user terminal 10 may also be configured so as to monitor operation of devices other than the multifunction machine 30 and register into the history database 55a the history data showing register processing specifics of the devices. The devices other than the multifunction machine 30 include various devices configured as peripheral equipment of a personal computer in addition to including a printer, a scanner, a facsimile, and the like.

What is claimed is:

1. A retrieval system comprising a search server and an information processing system, wherein the information processing system comprises:
a first communication unit that establishes communication with the search server;
a processing execution unit that executes a processing operation;
a generation unit that, if the processing execution unit performs a predetermined type of processing, generates a search formula corresponding to specifics of the performed processing and a message to describe a type of a search result corresponding to the search formula based on the specifics of the processing;
a search request unit that transmits search request data including the search formula and the message generated by the generation unit to the search server via the first communication unit; and
a display control unit that, upon receipt of response data in answer to the search request data from the search server via the first communication unit, displays an image of the response data on a display device, and
the search server comprises:
a second communication unit that establishes communication with the first communication unit provided in the information processing system;
a database that stores data;
a data extraction unit that, upon receipt of the search request data from the information processing system via the second communication unit, searches through the database by the search formula included in the search request data and extracts data matching the search formula from the database;
a display data generation unit that generates, as specifics of a result of search performed by the search formula included in the search request data, display data, which include a list of data extracted by the data extraction unit and the message included in the search request data and by which an image showing the list and the message is displayed on a display device; and
a response unit that transmits, as a response to the search request data, the display data generated by the display data generation unit to, via the second communication unit, the search request unit.

2. The retrieval system according to claim 1, wherein the database includes data relevant to data handled by the processing execution unit, and
the generation unit generates a search formula corresponding to the data handled during the processing, as a formula corresponding to specifics of the performed processing

3. The retrieval system according to claim 1, wherein the information processing system further comprises a history transmission unit that generates history data showing specifics of the performed processing if the processing execution unit performs a predetermined type of processing, and transmits the history data to the search server via the first communication unit, and
the search server further comprises a registration unit that, upon receipt of the history data from the information processing system via the second communication unit, registers the history data into the database.

4. The retrieval system according to claim 3, wherein the history transmission unit generates, as the history data, data showing a destination address to save the data handled during the processing and a date and time of the processing, and
the generation unit generates a search formula corresponding to the destination address to save the data handled during the processing, as a formula corresponding to specifics of the processing.

5. The retrieval system according to claim 3, wherein the history transmission unit generates, as the history data, data showing a destination address to save the data handled during the processing, a date and time of the processing, and a type of the processing, and
the generation unit generates, as a formula corresponding to specifics of the processing, a search formula, which corresponds to the destination address to save the data handled during the processing and which searches data corresponding to the type of the processing.

6. An information processing system comprising:
a processing execution device including a processing execution unit that executes a processing operation; and
a communications device including:
a first communication unit that establishes communication with a search server;
a generation unit that detects an operation of the processing execution unit of the processing execution device and generates, if the processing execution unit performs a predetermined type of processing, a search formula corresponding to specifics of the performed processing and a message to describe a type of a search result corresponding to the search formula based on the specifics of the processing;
a search request unit that transmits search request data including the search formula and the message generated by the generation unit to the search server via the first communication unit; and
a display control unit that, upon receipt of response data in answer to the search request data from the search server via the first communication unit, displays an image of the response data on a display device.

7. The information processing system according to claim 6, wherein the processing execution device is a multifunction machine.

8. A program product for enabling a computer to retrieve, comprising:
software instructions for enabling the computer to perform predetermined operations, and
a computer readable medium bearing the software instructions;
the predetermined operations including the steps of:
searching, upon receipt of search request data including a search formula and a message, through a predetermined database by the search formula included in the search request data and extracting from the database data matching the search formula;
generating, as specifics of a result of search performed by the search formula included in the search request data, display data, which include a list of extracted data and the message included in the search request data and by which an image showing the list and the message is displayed on a display device;
transmitting the display data as a response to the search request data to a device transmitting the search request data;
generating, if a predetermined type of processing is performed in a system to be monitored, a search formula corresponding to specifics of processing to be performed and a message describing a type of a search result corresponding to the search formula based on the specifics of processing to be performed; and
transmitting, to the server, search request data including the generated search formula and the generated message.
